(19) United States
(12) Patent Application Publication
(10) Pub. No.: US 2025/0000112 A1
(43) Pub. Date: Jan. 2, 2025

(54) EDIBLE COATING FOR PREVENTING THE FOOD SPOILAGE

(71) Applicant: AGROSUSTAIN SA, Renens (CH)

(72) Inventors: Olga DUBEY, Préverenges (CH); Sylvain DUBEY, Préverenges (CH); Florian GUIGNARD, Nyon (CH)

(73) Assignee: AGROSUSTAIN SA, Renens (CH)

(21) Appl. No.: 18/564,017

(22) PCT Filed: May 27, 2022
(86) PCT No.: PCT/EP2022/064428

§ 371 Date: Nov. 24, 2023

(30) Foreign Application Priority Data
May 27, 2021 (EP) 21176362.8

(51) Int. Cl. A23B 7/154; A23B 7/16; A23L 3/3517

(52) U.S. Cl. CPC A23B 7/154; A23B 7/16; A23L 3/3517

(57) ABSTRACT

An edible post harvest fruits, vegetables, cut flowers or seeds preservative biofilm coating composition, relating to the field of natural biofilms, in the form of an oil in water (O/W) emulsion. The edible coating composition extends the freshness of food and slowing down the ripening and water loss of post harvest fruits, vegetables, cut flowers or seeds.

### FIELD OF THE INVENTION

The invention relates to the field of natural biofilms for extending the freshness of food and slowing down the ripening and water loss. In particular, Applicants surprisingly provided a edible post harvest fruits, vegetables, cut flowers or seeds preservative coating composition in the form of an oil in water (O/W) emulsion and its use as a biofilm for extending the freshness and/or slowing down the ripening and/or water loss of post harvest fruits, vegetables, cut flowers or seeds.

### BACKGROUND OF THE INVENTION

Food waste on agricultural land and further down the supply chain is an all-too-common sight. More disturbingly, the Food and Agriculture Organization (FAO) estimates that approximately one third of global food production-worth around USD 1.66 trillion-goes to waste annually. According to the FAO, ‘If food waste were a country, it would be the 3^{rd} largest producer of greenhouse gases in the world (3.3 gt CO₂), after China (10.7gt) and the USA (5.3 gt). Fruits and vegetables are estimated to account for losses of up to USD 200 billion annually.

At present, chemical crop protection products are widely used in the agricultural and food industry to solve this issue. Unfortunately, many of these products have a detrimental effect on human and animal health and are consequently forbidden in countries such as Switzerland, Germany, France and the UK. At the same time, public sentiment to ban chemical pesticides and food additives has hardened.

Increasing global demand for high quality crops has resulted in post-harvest treatments in order to increase shelf life, prevent post-harvest loss, and maintain an attractive appearance, thereby contributing to the growth of the post-harvest market.

Factors such as the growing effort in reducing post-harvest losses, higher societal awareness and a growing consumer shift towards consumption of high quality fruits and vegetables, are expected to increase the demand for sustainable post-harvest treatments. The unrestrained growth of the fruits and vegetables industry is pushing producers to find more effective solutions for food safety and quality, thus encouraging the development of innovative post-harvest solutions.

The post-harvest treatment market for fruits and vegetables was valued at USD 1.17 Billion in 2017, and is projected to reach USD 1.67 Billion by 2022, at a CAGR of 7.3% (Post-harvest Treatment Market for Fruits & Vegetables-Global Forecast to 2022, Markets and Markets, 2017). The coating solutions market represents approx. CHF 300 MM annually. Such an insignificant market share is explained by the reduced offering of the effective, natural solutions that would provide freshness extension on more than 3 crops at a time.

Currently, once fruits and vegetables have been harvested, they must go through a storage and transport process to make them reach the final consumer. During this process, these products tend to lose moisture. In addition, there is also a problem due to exposure to various environmental conditions (temperature, humidity, biological and/or chemical contamination, among others), which leads to an increase in the probability of product putrefaction, added to this, poor home storage conditions extend post-harvest decay. The shelf life of fruits and vegetables during their commercialization is substantially reduced, implying a high economic impact in the production chain of these goods.

Various attempts to reduce food waste have already been tested and developed in the past.

Many efforts have been made in the post-harvest area to extend the shelf life of fruits and vegetables, within the solutions used to avoid the above problems, the conventional method corresponds to cold storage, in which various varieties of fruit they present affectations to their nutritional and organoleptic characteristics (eg original coloration, flavor and nutrients). In order to solve the aforementioned drawbacks, various waxy compositions were developed that include nanoparticles in various natural waxy components, useful for the coating and preservation of fruits and vegetables that add unique characteristics to the wax nanoparticles, including the ability to preserve color (which is conferred by a phytohormone) and integrate a bactericidal and fungicidal agent in its formulation.

WO 2021/187970 A1 (MARGREY INDS A DEC V [MX]) 23 Sep. 2021 (2021-09-23) relates to a wax-based coating for fruit and vegetables, which has the use of nanotechnology as a main advantage, since the nanoparticle emulsion has average sizes in the order of 35 nm and allows a more efficient coating to be achieved, as the film that surrounds the fruit is thinner, which allows better adherence between the coating and the fruit. This same phenomenon has an impact on the aspect of cleaning the area of application and on the economic aspect, since less product is required to achieve better effects (improved scarring and increased shelf life by reducing weight loss by dehydration, bacterial attack and enzymatic browning) by the included active agents (antioxidant agents and aprotic solvents). The wax-based coating for fruit and vegetables comprises at least one wax, at east one plasticising agent, at least one surfactant, at least one fatty acid, at least one co-emulsifier, at least one alkali, at least one polysaccharide, at least one aprotic solvent, at least one antioxidant and water.

CN 105 557 991 A (MAOMING ZEFENGYUAN AGRICULTURE PRODUCT CO LTD) 11 May 2016 (2016-05-11) discloses a fruit and vegetable fresh-keeping agent. The fruit and vegetable fresh-keeping agent disclosed contains moringa seed oil in formula, natural plant active ingredients are utilized for enhancing water-retaining property of fruits and vegetables, active antibacterial ingredients in the fruit and vegetable fresh-keeping agent can realize antibacterial effect, natural film forming matters inhibit respiratory metabolism effect of the fruits and vegetables, and refreshing time and shelf lives of the fruits and vegetables are prolonged. Compared with an existing chemical preservation agent, the fruit and vegetable fresh-keeping agent disclosed is safe and non-toxic, simple in preparation method and good in fresh-keeping effect. In particular, the fruit and vegetable preservative is characterized in that it comprises: 10-30 parts of Moringa seed oil, 30-60 parts of chitosan solution, 5-50 parts of ethanol solution of 45-60% mass fraction, 0.5-5 parts of potassium sorbate parts, 1-10 parts of emulsifier, and 10-800 parts of water.

WO 2018/174699 A1 (MARGREY INDS A DEC V [MX]) 27 Sep. 2018 (2018-09-27) relates to the development of compositions in the field of food engineering, particularly compositions including nanoparticles of different natural wax components, which can be used to coat and preserve fruit and vegetables, the formulation thereof containing a synergic combination that includes different components of the groups formed by lipids, natural waxes, proteins, carbohydrates and synthetic materials, wherein the preparation and emulsion of the compositions can be varied, using high-pressure methods, ultrasound methods and even low-energy methods. The document also relates to a preservation method for extending shelf life and reducing post-harvest decay of fruit and vegetables by applying a film of the wax compositions of the invention to the surface of the fruit and vegetables. In particular, the emulsified waxy composition comprises at least one natural waxy component, at least one plasticizing agent, at least one surfactant agent, an antifoaming agent, at least one alkali, glutaraldehyde, gibberellic acid and water.

Apparently, none of the documents mentioned above show that the waxy compositions are of preserved identity, using raw materials or components that are not genetically modified (NGMO), which allows the consumption of wax by human beings. It has not been shown that the waxy compositions have no effects on health and the same were not approved by various health regulations, including those of the FDA (the United States government agency responsible for the regulation of food, drugs, cosmetics, medical devices, biological products and derivatives blood), giving the possibility of using it anywhere in the world.

CN 103 859 015 A (UNIV ZHEJIANG) 18 Jun. 2014 (2014-06-18) discloses a bay laurel essential oil micro-emulsion cherry tomato preservative agent which consists of the following ingredients in percentage by weight: 0.1-5 percent of bay laurel essential oil, 5-25 percent of an emulsifier, 0.3-15 percent of a co-emulsifier and the balance being water. The weight ratio of the bay laurel essential oil to the co-emulsifier is 1:3, the emulsifier is Tween-20 or Tween-80, and the co-emulsifier is absolute ethyl alcohol or absolute propionic acid. The invention also discloses a preparation method of the bay laurel essential oil micro-emulsion cherry tomato preservative agent. The preservative agent can be used for effectively inhibiting the growth and propagation of pathogenic bacteria on the picked cherry tomatoes and reducing the rotting rate of the cherry tomatoes during a storage process.

EP 2962573 A1 discloses a method for preserving a fresh food product extending the shelf life of organoleptic, physical and alimentary properties of the fresh food product, comprising at least three steps in sequence, one step of cleaning residues from the fresh food product by washing said fresh food product with a liquid washing solution, a phase of immersion of said fresh food product in a mixture of water and honey at low concentration for a short immersion time comprising between 20 seconds and 100 seconds, said mixture of water and honey at low concentration provides that the honey has a concentration comprising between 10 grams per liter of water and 100 grams per liter of water, a step of refrigerating the fresh food product at a refrigeration temperature higher than zero degrees Celsius. However this method based on a single bathing is difficult to carry out in addition some fruits like zucchini fruits were looking really bad after this treatment.

U.S. Pat. No. 4,649,057 A (THOMSON TOM R [US]) discloses a preservative coating for fresh fruits and vegetables. The coating comprises approximately a 3 percent oil-in-water emulsion for which the active elements include approximately two parts partially hydrogenated vegetable oil and one part stearic acid and an anionic emulsifier. In particular, the composition for coating and preserving food consists essentially of an oil-in-water emulsion comprising by weight: approximately 100 to 200 grams of water, approximately 3 grams of a vegetable shortening, approximately 1.5 grams of stearic acid, approximately 0.3 grams of an anionic emulsifier, and approximately 0.15 grams of methylparaben. Also disclosed is a method of preparing the preservative coating for foods comprising the steps of: mixing a vegetable shortening, an anionic emulsifier and stearic acid to form a mixture, the ratio of said shortening and acid being substantially 2 to 1, respectively, said shortening and stearic acid is used in an amount sufficient to form an emulsion but no more than 5% of the emulsion, preheating approximately 100 to 200 grams of water to approximately 80 DEG Centrigrade, and adding and blending said mixture into said heated water to form an oil-in-water emulsion. The anionic emulsifier used in the coating composition is a high suds or a detergent like SDS, which is toxic for the human consumption.

WO 2020/226495 A1 LIQUIDSEAL HOLDING B V [NL] relates to an edible composition for coating fresh harvest products and a harvest product coated with said composition. The invention also relates to a method for coating an harvest product. In addition, the invention relates to the use of said edible composition for the preparation of a post-harvest fruit or vegetable item with prolonged shelf life and/or slower weight loss compared to a fruit or vegetable item which is not coated with said composition and to the use of said edible composition for the preparation of a post-harvest cut flower with prolonged vase life when coated with said composition compared to a comparable cut flower which is not coated with said composition. In particular, the edible composition for coating fresh harvest products is in the form of an aqueous emulsion, comprising: a monoglyceride or a diglyceride or a mixture thereof, wherein said monoglyceride and diglyceride have a chain length of 8 to 24 carbon atoms; one or more fatty acids; and one or more alkaline agents. The composition comprises ammonia which is not food grade and which stinks during the application.

The proposed solutions as referred above is the use of a coating that mainly inhibits the gaseous exchange of oxygen and carbon dioxide, reducing the loss of water and weight of the fruit, one of the main problems of this method being the permanence of the coating on the fruit or vegetable surface. Thus a further object of the invention is to provide such a coating in a formulation that does not include resins, shellacs, waxes or paraffins which are difficult to remove prior to consumption of the food product.

Nor can it be seen in the documents cited above that it is possible to avoid the generation of foam and facilitate the manipulation of viscous solutions having a low surface tension, which allows a better coverage of the fruits and vegetables, reducing the drying time, another of the benefits that the proposed invention has and that are not evidenced in the cited documents, is the low friction that already coated fruits and vegetables have.

Therefore, the reduction of food waste, occurring during storage and transportation of fast perishable crops, is still a key challenge for industry participants.

The present invention aims to provide a improved easy-to-make edible coating strictly made of food-grade compounds, which do not present one or more of the drawbacks of the state of the art methods and products.

In particular, the present invention aims to provide cost effective and robust natural biofilms for extending the freshness of food and slowing down the ripening and water loss. It consists of a coating in the form of an oil in water microemulsion which is easy to apply on fruits or vegetables.

### BRIEF DESCRIPTION OF THE INVENTION

In the present invention, Applicants have identified plant extracts that can be used as efficient biofilms extending the freshness of fruits (i.e. slower ripening and water loss). In particular, Applicants have surprisingly developed an edible coating composition for fruit, vegetable, flowers or other perishable goods to improve post-harvest properties and improve storage; the composition consisting of vegetable oils, water and a mixture of two emulsifiers, being non-ionic sucrose fatty acid esters.

It is one object of the present invention to provide an use of an edible coating emulsion consisting in the combination of:
natural vegetable oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof;
a mixture of two nonionic sucrose fatty acid ester emulsifiers consisting of sucrose monoester and sucrose polyester, wherein the percentage of sucrose monoester versus sucrose polyester is comprised between 30 and 70% in weight of each of said two nonionic sucrose fatty acid ester emulsifiers corresponding to a final hydrophilic-lipophilic balance (HLB) of the mixture of said two nonionic sucrose fatty acid ester emulsifiers which is comprised between 6 and 15;
and water;
   as a biofilm for extending the freshness and/or slowing down the ripening and/or water loss of post-harvest fruits, vegetables, cut flowers, seeds and perishable food products.

It is another object of the invention to provide an edible post-harvest fruits, vegetables, cut flowers, seeds and perishable food products preservative coating composition in the form of an oil in water (O/W) emulsion consisting in the combination of:
natural vegetable oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof;
a mixture of two nonionic sucrose fatty acid ester emulsifiers consisting of sucrose monoester and sucrose polyester, wherein the percentage of sucrose monoester versus sucrose polyester is comprised between 30 and 70% in weight of each of said two nonionic sucrose fatty acid ester emulsifiers corresponding to a final hydrophilic-lipophilic balance (HLB) of the mixture of said two nonionic sucrose fatty acid ester emulsifiers which is comprised between 6 and 15;
and water.

Other objects and advantages of the invention will become apparent to those skilled in the art from a review of the ensuing detailed description, which proceeds with reference to the following illustrative drawings, and the attendant claims.

### BRIEF DESCRIPTION OF THE FIGURES

FIG. 1: Represents differences in weight loss between non-coated carrots versus coated carrots with various oil emulsions, 6 days after the beginning of the experiment performed at room temperature (22° C.).

FIG. 2: Represents differences in weight loss between non-coated bananas versus coated bananas with various oil emulsions, 6 days after the beginning of the experiment performed at room temperature (22° C.).

FIG. 3: Represents differences in ripening between non-coated bananas versus coated bananas with various oil emulsions, 6 days after the beginning of the experiment performed at room temperature (22° C.).

FIG. 4: Represents differences in weight loss between non-coated bananas versus coated bananas with various oil emulsions, 9 days after the beginning of the experiment performed at room temperature (22° C.).

FIG. 5: Represents differences in weight loss between non-coated bananas versus coated bananas with various oil emulsions (19 vegetable oils were tested), 6 days after the beginning of the experiment performed at room temperature (22° C.).

FIG. 6: Represents differences in ripening between non-coated mangoes versus coated mangoes with various oil emulsions, 8 days after the beginning of the ripening at room temperature (22° C.).

FIG. 7: Represents differences in weight loss between non-coated zucchinis versus coated zucchinis with various oil emulsions, 10 days after the beginning of the experiment performed at room temperature (22° C.).

FIG. 8: Represents differences in weight loss between non-coated bananas versus coated bananas with various emulsions (5 oils and butters from animal origin were tested), 6 days after the beginning of the experiment performed at room temperature (22° C.).

FIG. 9: Compares the water loss in (i) carrots treated with strictly sucrose esters (SP30/SP70; CT13 and CT6) to coatings made of sucrose esters (SP30/SP70) and a combination of olive and canola oils (Beta and Beta W, respectively) and (ii) zucchinis treated strictly with sucrose esters (SP30, CT28; SP70, CT27) and coatings made of sucrose esters and vegetable oils (CT21 [SP30+canola oil] and CT23 [SP70+combination of olive and canola oils] respectively).

FIG. 10: Represents differences in weight loss between non-coated pineapples (control) versus coated pineapples with various concentrations of oil emulsions (3, 5, 8, 10 and 12%; combination of olive and canola oils and sucrose esters, i.e. SP30/SP70) and Pineapple Lustr 444® from Decco® (containing microcrystalline wax) at 7%, after 9 days stored at 8° C. (FIGS. 10. A) and 11 days (FIG. 10. B) comprising 9 days stored at 8° C. and two days stored at 22° C.).

FIG. 11: Represents differences in weight loss between non-coated bananas (control) versus coated bananas with an oil emulsions at 15% (combination of olive and canola oils and sucrose esters, i.e. SP30/SP70) and coatings prepared according to WO 20211/87970 A1, WO 2018/174699 A1, CN 105557991 A, CN 103859015 A, as well as Pineapple Lustr 444® from Decco® at 7%, and a mixture of canola and olive oils, after 2 days stored at 22° C.

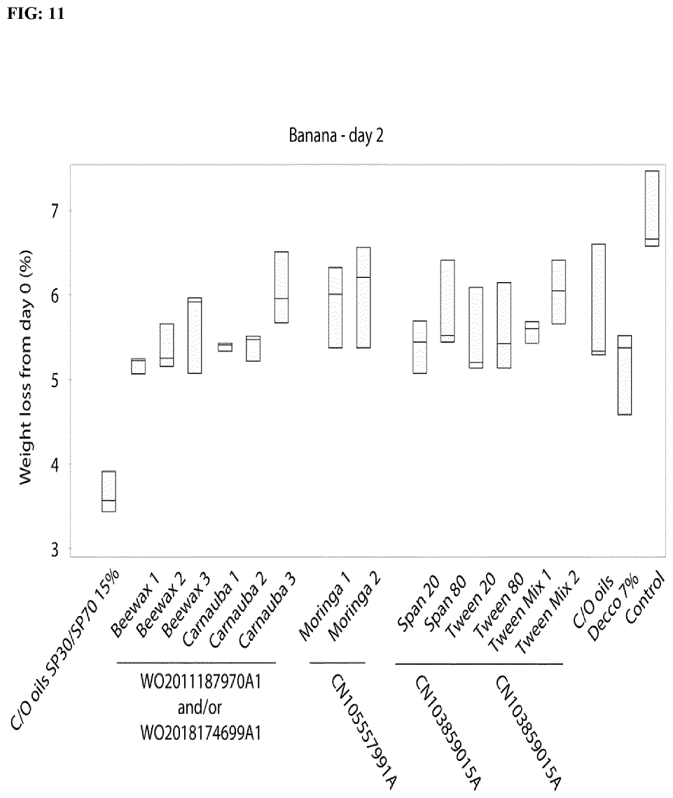

FIG. 12: Represents differences in weight loss between non-coated bananas (control) versus coated bananas with oil emulsions at 15% of a single oil (canola, safflower, olive and sunflower) or a combination of both of them, after 11 days stored at 22° C.

### DETAILED DESCRIPTION OF THE INVENTION

Although methods and materials similar or equivalent to those described herein can be used in the practice or testing of the present invention, suitable methods and materials are described below. All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

In the case of conflict, the present specification, including definitions, will control.

Unless defined otherwise, all technical and scientific terms used herein have the same meaning as is commonly understood by one of skill in art to which the subject matter herein belongs. As used herein, the following definitions are supplied in order to facilitate the understanding of the present invention.

The term “comprise” is generally used in the sense of include, that is to say permitting the presence of one or more features or components.

Accordingly, a “consisting in or consisting of” claim format is typically understood by the case law to signal a closed claim that excludes any items not expressly recited in the claim.

As used in the specification and claims, the singular forms “a”, “an” and “the” include plural references unless the context clearly dictates otherwise.

The presence of broadening words and phrases such as “one or more,” “at least,” “but not limited to” or other like phrases in some instances shall not be read to mean that the narrower case is intended or required in instances where such broadening phrases may be absent.

The terms «coating» and «biofilms» refer to the process of covering fruits, vegetables or any kind of food with a film of biological origin.

The term «oil» refers to the oil/butter extraction from the other fruits and/or seed contents such as solid material and liquid, but also include any other lipophilic and hydrophilic compounds from the plants that could end up in the oil/butter through the extraction process.

“Natural vegetable oils” or in general, natural oils are obtained from the most varied parts of oil-containing plants. Depending on the type of plant, different plant parts such as the seeds, fruits, leaves, flowers, stems, barks, woods (including their resins) or roots can be used for this purpose. The term “natural” is used to refer to a non synthetic material.

Natural vegetable oil include for example argan, avocado, canola, safflower, castor, coconut, grape seed, hazelnut, hemp seed, linseed, olive, palm, peanut, pumpkin seed, sesame, sunflower and walnut or mixtures thereof.

For the purpose of this invention “a plant” refers to a living organism of the kind exemplified by trees, shrubs, herbs, grasses, ferns, and mosses, typically growing in a permanent site, absorbing water and inorganic substances through its roots, and synthesizing nutrients in its leaves by photosynthesis using the green pigment chlorophyll.

The terms “applying”, “application”, “treating”, “treated”, “administering”, “administer”, or “administered” relate to the application of the compositions disclosed herein to a seed, a seedling, a plant, or a plant part. The compositions may be applied to a seed, a seedling, a plant, or a plant part by spray application, drenching, watering/sprinkler systems, or soaking. For example, seeds can be soaked, sprayed, or washed with compositions as disclosed herein prior to packaging or planting.

The terms “about”, “approximately”, “approximate”, and “around” are used in this patent application to describe some quantitative aspects of the invention. It should be understood that absolute accuracy is not required with respect to those aspects for the invention to operate. When these terms are used to describe a quantitative aspect of the invention the relevant aspect may be varied by up to +10%. Thus, the terms “about”, “approximately”, “approximate”, and “around” allow for variation of the various disclosed quantitative aspects of the invention by ±1%, ±2%, ±3%, ±4%, ±5%, ±6%, ±7%, ±8%, ±9%, or up to ±10%. For example, 10% plant extract can contain 9% to 11% of the plant extract.

As used herein the term “extract” refers to an active preparation derived from plant material. In the context of this specification, by “active” it is meant that the extract is capable of producing a desired effect as disclosed herein. An extract is obtained by a process of “extraction” which will be understood by those skilled in the art as a method for extracting the active principles. The extraction process may comprise treating plant material with a liquid, or a supercritical fluid to dissolve the active preparation and separate the same from residual unwanted plant material. An extract may be in liquid form (for example as a decoction, solution, infusion or tincture) or solid form (for example as a powder or granules).

Exemplary extraction processes include treatment with food-grade solvents including hexane, acetone, ethanol, water or mixture thereof, mechanical extraction by grounding the plants (e.g. vegetable oil), mixing with oil, then heating, stirring and press filtering, supercritical carbon dioxide extraction in multiple steps using pressurised hot water extraction with small amounts of ethanol, ultrasound-assisted methanol extraction and hydrodistillation and maceration with ethanol.

Fruits and veggies are fresh produce, which not only means that they are sold as fresh goods, but they also must be consumed while they are still fresh. The problem with so much freshness is that it significantly shortens the shelf life of food, and as a result, fruits and vegetables have a short lifespan.

Agricultural products are highly perishable, which makes shelf life a vital issue for growers, processors and retailers. Shelf life itself is defined as the period of time a food has before it is considered unsuitable for sale or consumption, and, for fresh agricultural products, this can vary considerably, depending on multiple factors. The key consideration behind the post-harvest shelf life of agricultural products is the fact that they continue to function as living organisms via the respiration process even after they are gathered. Agricultural products respire after harvest by using stored energy and oxygen, as well as continue their ripening. It's important to extend the shelf-life of agricultural products not only to reduce food waste, but also to eliminate the risk of food-related illness from mould or pathogen contamination.

The terms “vegetables” and “veggies” are used for a plant or part of a plant used as food, including such as e.g. some fruits, leaves, stems, roots and tubers.

Ripening is a process in fruits that causes them to become more palatable. In general, fruit becomes sweeter, less green (typically “redder”), and softer as it ripens. Even though the acidity of fruit increases as it ripens, the higher acidity level does not make the fruit seem tarter. This effect is attributed to the Brix-Acid Ratio. Underripe fruits are also fibrous, less juicy, and have tougher outer flesh than ripe fruits.

A “natural composition” or natural product is a chemical compound or substance produced by a living organism that is found in nature. In the broadest sense, natural products or composition include any substance produced by life. The term natural product has also been extended for commercial purposes to refer to cosmetics, dietary supplements, and foods produced from natural sources without added artificial ingredients.

Bacteria and/or fungi are among the main culprit of food waste, and they need nutrients and moisture in order to grow and multiply. Therefore, controlling the moisture or water content of food is one of the most important means of extending the shelf life of food products. The “shelf life” is the time during which a product will remain safe, maintain desired sensory, chemical and physical properties, and comply with nutritional labelling. After this period the food must be thrown away as it will be unsafe for consumption.

“Perishable food products” are those that spoil the most quickly and require refrigeration. Non-perishable foods, on the other hand, are those that will take a long time to spoil and don't require refrigeration. Perishable food products means food products that will become unfit for human consumption unless they are stored, treated, packaged or otherwise conserved to prevent them from becoming unfit. In other words, perishable food products means agricultural and food products which are naturally suitable for commercialisation and consumption for a period of up to thirty days or that require regulated temperature or packaging conditions for storage, and/or commercialisation and/or transportation. Examples of perishable foods that must be kept refrigerated for safety include meat, poultry, fish, dairy products, and all cooked leftovers. Refrigeration slows bacterial growth and freezing stops it. There are two completely different families of bacteria that can be on food: pathogenic bacteria, the kind that cause foodborne illness, and spoilage bacteria, the kind of bacteria that cause foods to deteriorate and develop unpleasant odors, tastes, and textures.

Perishable food products also include “processed food”. By definition, a processed food is a food item that has had a series of mechanical or chemical operations performed on it to change or preserve it. Processed foods are those that typically come in a box or bag and contain more than one item on the list of ingredients.

A “seed” is an embryonic plant enclosed in a protective outer covering. The formation of the seed is part of the process of reproduction in seed plants, the spermatophytes, including the gymnosperm and angiosperm plants. Seeds are the product of the ripened ovule, after fertilization by pollen and some growth within the mother plant. The term “seed” also has a general meaning that antedates the above-anything that can be sown, e.g. “seed” potatoes, “seeds” of corn or sunflower “seeds”. In the case of sunflower and corn “seeds”, what is sown is the seed enclosed in a shell or husk, whereas the potato is a tuber.

Many structures commonly referred to as “seeds” are actually dry fruits. Plants producing berries are called baccate. Sunflower seeds are sometimes sold commercially while still enclosed within the hard wall of the fruit, which must be split open to reach the seed. Different groups of plants have other modifications, the so-called stone fruits (such as the peach) have a hardened fruit layer (the endocarp) fused to and surrounding the actual seed. Nuts are the one-seeded, hard-shelled fruit of some plants with an indehiscent seed, such as an acorn or hazelnut. Coffee beans and green coffee are also included within this terminology.

There are two basic types of water and oil emulsions. Relatively low oil contents produce oil-in-water (O/W) emulsions while relatively low water contents produce water-in-oil (W/O) emulsions. In an oil-in-water emulsion, very fine droplets of oil are suspended in the water, while in a water-in-oil emulsion, water droplets are suspended in the oil. An emulsifying agent is a substance that is attracted to both the water and the oil. The emulsifying agent is thus attracted to the interfaces of the suspended droplets where it tends to sustain the emulsified state of the mixture.

The oil-in-water emulsion was preferred over a water-in-oil emulsion for two reasons: First, the oil-in-water emulsion yields a thinner and more easily applied coating material. Second, the oil-in-water emulsion is preferred in terms of its characteristics relative to preventing mold growth. Molds form and grow best in water that is deprived of air. In an oil-in-water emulsion, the water phase is exposed to air, while in a water-in-oil emulsion, which usually is a cream rather than a liquid, the suspended water droplets are sealed off by the surrounding oil body, thus providing an anaerobic environment for organisms that usually are found in the aqueous phase.

### Emulsifier:

An emulsifier is an additive which helps two liquids mix. For example, water and oil separate in a glass, but adding an emulsifier will help the liquids mix together. An emulsifier consists of a water-loving hydrophilic head and an oil-loving hydrophobic tail. The hydrophilic head is directed to the aqueous phase and the hydrophobic tail to the oil phase. The emulsifier positions itself at the oil/water or air/water interface and, by reducing the surface tension, has a stabilising effect on the emulsion. Emulsifiers belong to the surfactants, usually with a grease-loving (lipophilic) and a water-loving (hydrophilic) part, which can nest around boundary layers between aqueous and greasy parts. Grease and water repel each other, making an emulsion without emulsifier easily fall apart. An emulsifier prevents this rejection because it projects the water-loving side towards the water and the fat-loving side towards the fat. The extent to which the hydrophilic or lipophilic character dominates is represented by the HLB value of the surfactant (HLB=Hydrophilic-Lipophilic Balance). A high HLB value (10 to 18) indicates a hydrophilic substance suitable for emulsifying fats or oils in water. Substances with a low HLB (3 to 8) are lipophilic and suitable for water-in-oil emulsions.

An “ionic emulsifier” is one that has an electric charge. There are three types of ionic surfactant:
Anionic (negatively charged)
Cationic (positive charge)
Amphoteric (contains a positive and negative charge)

“Nonionic emulsifiers” contain no charge. Structurally, nonionic emulsifiers combine uncharged hydrophilic and hydrophobic group that make them effective in wetting and spreading and as foaming agents.

### Sucrose Ester:

Sucrose ester emulsifiers are a class of synthetic emulsifiers that are obtained by chemically esterifying a sucrose molecule with one or more fatty acids (or glycerides).

Sucrose is a disaccharide consisting of a glucose and a fructose subunits bound together via an ether bond. It has the molecular formula C₁₁H₂₂O₁₁ and has the IUPAC name of β-D-Fructofuranosyl α-D-glucopyranoside. It possesses 8 hydroxyl group (—OH), which can be esterified as in the case of sucrose ester emulsifiers.

Fatty acids are molecules consisting of a carboxylic acid (—COOH) and an aliphatic chain, that can be either saturated (no carbon-carbon double bond in the chain) or unsaturated (one or more carbon-carbon double bond). In nature, the carbon chains usually have an even number of carbon ranging from 4 to 28. They also exist as esters, such as triglycerides or phospholipids, where the carboxylic acid has reacted with an alcohol to form an ester bond.

For sucrose ester emulsifiers, depending on the lengths of the fatty acid carbon chains (typically between C₁₂ and C₂₂) and on the number of fatty acid chains per sucrose molecules (mono-, di- and tri-esters mainly), a wide range of Hydrophilic-Lipophilic Balance between 2 and 18 can be covered. These molecules are approved and registered in the European Union by the European Food Safety Authority (EFSA) under the E number E473. They are typically produced by interesterification between sucrose and fatty acid methyl esters. As emulsifiers, they are used in cosmetics, pharmaceutical and food applications thanks to their broad emulsifying properties.

The “Hydrophilic-Lipophilic Balance” (HLB) is a value used to characterize the degree to which an emulsifier is hydrophilic or lipophilic, and ranges from 0 to 20. The lower the HLB value, the more hydrophobic the molecule is. For non-ionic emulsifiers, the method was first described by Griffin in 1949 for molecules like polyethylene oxide (PEO) (Griffin, William C. (1949), “Classification of Surface-Active Agents by ‘HLB” (PDF), Journal of the Society of Cosmetic Chemists, 1 (5): 311 26), and has been adapted for sucrose esters.

The HLB of commercially available sucrose ester emulsifiers can be tuned by varying the degree of interesterification or by changing the length of the carbon chain of the fatty acids. For a given carbon chain length, a monoester (one fatty acid ester per sucrose unit) is more hydrophilic than a diester (two fatty acid esters per sucrose molecule), while the triester (three fatty acid esters per sucrose molecule) is the most hydrophobic one.

“Sucrose monoesters” consist of a sucrose molecule with one fatty acid ester on it, while “sucrose polyesters” comprise all sucrose molecules having more than one fatty acid ester on it (including diesters, triesters, etc.,).

Alternatively, for a given number of fatty acid esters per sucrose molecule, the longer the carbon chains of the fatty acid, the more hydrophobic (the lower the HLB) the sucrose ester emulsifier is.

However, even if these two ways of tuning the HLB exist, the degree of transesterification has a more important impact on the HLB than the length of the fatty acid carbon chain. To prepare a hydrophobic sucrose ester, it is more efficient to reduce the weight percentage of sucrose monoester (versus the sucrose polyester) than shortening the length of the fatty acid carbon chain.

Sisterna®, a company manufacturing and selling sucrose ester emulsifiers for cosmetic and food applications, has products with HLB ranging from 1 to 16. They use a mixture of stearic acid (C₁₈) and palmitic acid (C₁₆) for interesterification and tune the HLB of the final product by changing the percentage of monoester; the more monoester in the blend, the more hydrophilic it is (high HLB). Such products can be found at https://www.sisterna.com/food/product-range/Another company, Mitsubishi Chemical Corporation®, also sells similar products under the name Ryoto Sugar Ester®. Differently from Sisterna®, they use fatty acids of different chain length, and not the same mixture of palmitic/stearic acid. For example, they use lauric acid (C₁₂) or behenic acid (C₂₂). They also use fatty acids with unsaturated carbon chain such as oleic acid (C₁₈-mono unsaturated) or erucic acid (C₂₂-mono unsaturated). These products can be found at https://www.mfc.co.jp/english/ryoto_se/seihin.htm

It is one object of the present invention to provide the use of an edible coating emulsion consisting in the combination of:
natural or non-synthetic vegetable oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof;
a mixture of two nonionic sucrose fatty acid ester emulsifiers consisting of sucrose monoester and sucrose polyester, wherein the percentage of sucrose monoester versus sucrose polyester is comprised between 30 and 70% in weight of each of said two nonionic sucrose fatty acid ester emulsifiers corresponding to a final hydrophilic-lipophilic balance (HLB) of the mixture of said two nonionic sucrose fatty acid ester emulsifiers which is comprised between 6 and 15;
and water;
   as a biofilm for extending the freshness and/or slowing down the ripening and/or water loss of post-harvest fruits, vegetables, cut flowers, seeds and perishable food products.

Preferably, said natural vegetable oils are cold pressed oils which are selected from the group consisting of argan, avocado, canola, safflower, castor, coconut, grape seed, hazelnut, hemp seed, linseed, olive, palm, peanut, pumpkin seed, sesame, sunflower and walnut or mixtures thereof.

More preferably, said natural vegetable oils correspond to a mixture of two natural vegetable oils selected from the group consisting of canola, olive and sunflower.

According to a preferred embodiment of the invention, the percentage of sucrose monoester versus sucrose polyester is 60% in total weight of said two sucrose fatty acid ester emulsifiers corresponding to a final hydrophilic-lipophilic balance (HLB) of 13.

According to another embodiment, the two nonionic sucrose fatty acid ester emulsifiers represent between 0.15% w/w and 1.5% w/w of the total weight of the edible coating emulsion.

The edible coating emulsion of the invention comprises two nonionic sucrose fatty acid ester emulsifiers having different lipophilic balances. As explained above, lipophilic balances are given by the HLB and the HLB of commercially available sucrose ester emulsifiers can be tuned by varying the degree of interesterification or by changing the length of the carbon chain of the fatty acids.

Preferably, said two nonionic sucrose fatty acid ester emulsifiers having different lipophilic balances are selected from the list comprising the sucrose monostearate and di or tri or polystearate alpha-D-Glucopyranoside, beta-D-fructofuranosyl, mixed palmitates and stearates i.e. SP70 and SP30. Preferably, said two nonionic sucrose fatty acid ester emulsifiers are mixed palmitates and stearates SP70 and SP30.

According to a preferred embodiment of the invention, the edible coating emulsion is a microemulsion having an average particle size distribution of the oil droplets in the coating emulsion of around 20 micrometer in diameter.

Preferably, the natural vegetable oil represents at least 0.3% w/w of the total weight of the edible coating emulsion. Most preferably, the natural vegetable oil represents between 0.3% and 2.5% w/w of the total weight of the edible coating emulsion.

Advantageously, a natural fungicide or a formulation containing a natural fungicide can be added or combined to the edible coating emulsion of the invention.

Preferably the natural fungicide is an isothiocyanate derivative as described in WO2020011750 (A1) (UNIV DE LAUSANNE [CH]).

Other non natural fungicides may also be used such as the fungicides selected from the group comprising: azoxystrobin, cyproconazole, mandipropamide, zoxamide, copper oxysulfate, cymoxanil, fenpropidine, difenoconazole, propiconazole, captan, cyprodinil, copper oxychlorure, aluminium fosetyl, folpet, dithianon, potassium phosphate, mancozeb, cyflufenamide, difenoconazole, benzovindiflupyr, prothioconazole, metalaxyl, fluazinam, boscalid, tebuconazole, bupirimate, epoxiconazole, fenpropimorph, fluxapyroxad, fludioxonil, trifloxystrobine, sulfur metrafenone, hydrogen peroxide, peroxyacetic acid, chlorothalonil, iprodione, liquid hydrocarbons, flutolanil, propamocarb monohydrochloride, pyrimethanil, Dodine, Copper octanoate, triadimenol, cupric hydroxide, thiabendazole, Epoxyconazol, Prochloraze, thiophanate-methyl, triflumizole, mancozebe, picoxystrobine, fenbuconazole, myclobutanil, quinoxyfene, famoxadone, metiram, potassium phosphite, flutriafol, bixafen, kresoxim-methyl, Fluoxastrobin, Thiophanate methyl, Ziram, Polyoxin-D zinc salt, Chlorothalonil, Triphenyltin hydroxide, ethaboxam, mandestrobin, clothianidin, pconazole, proquinazide, strobilurin and triazole, triforine, thiram, cyazofamid, isofetamide, nuarimol, spiroxamine, propamocarbe, epoxiconazole, ametoctradine, dimethomorph, fenpyrazamine, xemium, penthiopyrad.

Advantageously, the edible coating emulsion of the invention is suitable for use in the coating of fruit and vegetable storage boxes.

It is yet another object of the invention to provide an edible post harvest fruits, vegetables, cut flowers, seeds and perishable food products preservative coating composition in the form of an oil in water (O/W) emulsion comprising the combination of:
natural or non-synthetic vegetable oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof;
a mixture of two nonionic sucrose fatty acid ester emulsifiers consisting of sucrose monoester and sucrose polyester, wherein the percentage of sucrose monoester versus sucrose polyester is comprised between 30 and 70% in weight of each of said two nonionic sucrose fatty acid ester emulsifiers corresponding to a final hydrophilic-lipophilic balance (HLB) of the mixture of said two nonionic sucrose fatty acid ester emulsifiers which is comprised between 6 and 15; and water.

Preferably the perishable food products are selected from the group comprising fruits and vegetables at any maturation stage or any material from plant origins, seeds, meat or fish and/or processed food. More preferably the food is selected from the group comprising fruits and vegetables at any maturation stage.

Preferably, said natural vegetable oils are cold pressed oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof. More preferably, said natural vegetable oils correspond to a mixture of two natural vegetable oils selected from the group consisting of canola, olive and sunflower.

According to a preferred embodiment of the invention, the percentage of sucrose monoester versus sucrose polyester is 60% in total weight of said two sucrose fatty acid ester emulsifiers corresponding to a final hydrophilic-lipophilic balance (HLB) of 13.

According to another embodiment, the two nonionic sucrose fatty acid ester emulsifiers represent between 0.15% w/w and 1.5% w/w of the total weight of the edible coating emulsion.

The edible coating emulsion of the invention comprises two nonionic sucrose fatty acid ester emulsifiers having different lipophilic balances.

Preferably, said two nonionic sucrose fatty acid ester emulsifiers having different lipophilic balances are selected from the list comprising the sucrose monostearate and di or tri or polystearate alpha-D-Glucopyranoside, beta-D-fructofuranosyl, mixed palmitates and stearates i.e. SP70 and SP30. Preferably, said two nonionic sucrose fatty acid ester emulsifiers are mixed palmitates and stearates SP70 and SP30.

Advantageously, the edible coating emulsion is a microemulsion having an average particle size distribution of the oil droplets in the coating emulsion of around 20 micrometer in diameter.

In one embodiment, the natural vegetable oils represent at least 0.3% w/w of the total weight of the edible coating emulsion. Preferably, the natural vegetable oils represent between 0.3% and 2.5% w/w of the total weight of the edible coating emulsion.

According to a preferred embodiment, a natural fungicide as exemplified above can be added or combined to the edible coating emulsion of the invention.

It is yet another object of the present invention to provide a process for preparing the edible coating composition in the form of an oil in water (O/W) emulsion according to the invention, said process comprising the steps of:
adding two nonionic sucrose fatty acid ester emulsifiers consisting of sucrose monoester and sucrose polyester, wherein the percentage of sucrose monoester versus sucrose polyester is comprised between 30 and 70% in weight of each of said two nonionic sucrose fatty acid ester emulsifiers corresponding to a final hydrophilic-lipophilic balance (HLB) of the mixture of said two nonionic sucrose fatty acid ester emulsifiers which is comprised between 6 and 15; in water and heating the resulting water phase at a temperature between 55° C. and 80° C., allowing the two nonionic sucrose fatty acid ester emulsifiers to dissolve,
heating natural vegetable oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof at least at 5° C. less than the water phase to obtain an homogeneous oil phase,
mixing the oil phase to the water phase and heating said mixture for at least approximately 25 minutes at least at a temperature between 55° C. and 80° C., allowing said two nonionic sucrose fatty acid ester emulsifiers to dissolve, and cooling the resulting mixture down.

According to one embodiment of the invention, the obtained mixtures are diluted from 5% to 20% in weight in water to prepare a ready for spray or ready for bath edible coating composition in the form of an oil in water (O/W) emulsion.

The harvest product to be coated is suitably selected from the group of a fruit item, a vegetable, a flower bulb and a cut flower, preferably it is a fruit item or a vegetable item. The invention therefore also relates to a post-harvest product, coated with the composition according to the invention, wherein the post-harvest product is suitably as specified above.

Fruit items can be any edible fruit items, including fruit items with a thick peel that has to be peeled off before consumption, or fruit items with a thin edible peel. Non-limiting examples of fruit items that can be coated with the composition of the invention include without limitation banana, mango, melon, citrus fruits, papayas, lychees, oranges, apples, apricots, avocados, bananas, cantaloupes, figs, guavas, kiwis, nectarines, peaches, pears, persimmons, plums, passion fruit, strawberries, blackberries and tomatoes, etc.

Examples of vegetables that can be coated with the composition of the invention include without limitation green vegetables, orange vegetables, starchy vegetables, root vegetables, peas and beans, and other vegetables, for instance celery, green beans, green peppers, snow peas, snap peas, asparagus, zucchini, broccoli, cucumbers, onions, etc.

Examples of cut flowers that can be coated with the composition of the invention include without limitation, tulips, roses, chrysanthemums, gladioli, lilies, gardenias, orchids, poinsettias, etc.

Coating fruit and vegetables with the coating according to the invention leads to prolonged shelf life and slower weight loss of said fruit or vegetable. In this respect the invention also relates to the use of the composition according to the invention, for the preparation of a post-harvest fruit or vegetable item with prolonged shelf life and slower weight loss compared to a comparable fruit or vegetable item which is not coated with said composition. With “comparable fruit or vegetable item” is meant a fruit or vegetable item of the same variety, with substantially similar size and at an equal stage in time after harvest.

Coating cut flowers with the coating according to the invention leads to prolonged vase life of said flowers. In this respect the invention also relates to the use of the composition according to the invention, for the preparation of a post-harvest cut flower with prolonged vase life when coated with said composition compared to a comparable cut flower which is not coated with said composition. With “comparable cut flower” is meant a flower of the same variety, with substantially similar size and at an equal stage after cutting.

The invention also relates to a method for coating a fresh post-harvest product, selected from the group of a fruit item, a vegetable and a cut flower and comprising applying post-harvest to said harvest product a composition according to the invention.

The coating emulsion can be applied by several techniques, preferably by spraying or immersion in a bath. When the coating emulsion used has a high viscosity, preferably a dilution of the emulsion is used for applying the emulsion, whereas with an emulsion with a low viscosity, preferably a spraying/immersion technique is used. The coating is allowed or made to dry after being applied.

In case of a concentrated composition with low water content, the composition is diluted prior to use.

The method may result in a thickness of the coating of 5-20 micrometers. This can be achieved in a single coating step, for instance by immersion or spraying.

It is also possible to apply multiple coating steps, for instance in two steps. In this case the first coating step results in a primer layer and the second step in a “finishing” layer. For the sake of efficiency it is however preferred that coating is performed in a single step.

The emulsion of the coating composition according to the invention may be applied one or more times directly on the fruit items. Preferably the emulsion is applied once. The emulsion of the coating composition according to the invention is applied directly on the harvest products and is edible. The composition is applied at least on the skin of the harvest products, although applying the composition also on stems and or broken surfaces thereof will not be detrimental to gloss and weight stability.

Those skilled in the art will appreciate that the invention described herein is susceptible to variations and modifications other than those specifically described. It is to be understood that the invention includes all such variations and modifications without departing from the spirit or essential characteristics thereof. The invention also includes all of the steps, features, compositions and compounds referred to or indicated in this specification, individually or collectively, and any and all combinations or any two or more of said steps or features. The present disclosure is therefore to be considered as in all aspects illustrated and not restrictive, the scope of the invention being indicated by the appended Claims, and all changes which come within the meaning and range of equivalency are intended to be embraced therein.

The foregoing description will be more fully understood with reference to the following Examples. Such Examples, are, however, exemplary of methods of practising the present invention and are not intended to limit the scope of the invention.

### Example 1

Applicants developed coatings to improve shelf life of fresh fruits and vegetable. If not stated otherwise, the preparation of the emulsion was done on a Kenwood Cooking Chef Gourmet KC9040S robot, with the K-Haken stirrer. The abbreviation CT stands for Cooking Test.

1a Emulsion Preparation with Ethanol—a, C, Beta w, CT7

The water phase was prepared by mixing 367 g of MilliQ water with 35 g of SP70 sucrose ester emulsifier, 0.5 g of potassium sorbate (E202) preservative and heating this solution to 80° C. with the stirring speed set on level 1.

The oil phase was prepared by mixing 50 g of ethanol and 10 g of SP30 sucrose ester emulsifier and heating to 65° C. on an IKA Basic heating plate, with a stirring speed of 300 rpm. After the solution became homogeneous, 40 g of vegetable oils (all those used in example 5; canola oil for C; olice oil for A, 50/50 vol % canola/olive for beta; or oleic acid for CT7) was added and the solution was heated to 75° C., before being added to the water phase. The emulsion was kept at 80° C. for 25 minutes, with a stirring speed set on minimum speed. The heating was then stopped, and the emulsion was cooled down to room temperature with the stirring on.

To test the impact of the amount of emulsifier used, the same recipes was done by using 2× (CT4) and 10× (CT3) less sucrose ester, otherwise keeping all the other parameters the same.

1b Emulsion Preparation without Ethanol—CT15, CT22, CT30, Beta

The water phase was prepared by mixing 367 g of MilliQ water with 35 g of SP70 sucrose ester emulsifier, 10 g of SP30 sucrose ester emulsifier, 0.5 g of potassium sorbate (E202) preservative and heating this solution to 80° C. with the stirring speed set on level 1. A batch using only 5 g of SP30 while keeping all other parameters constant was also prepared (CT30). 40 g of vegetable oil (CT22)), of a 50/50 vol % mixture of olive and canola oil (beta) or of oleic acid (CT15) was heated to 75° C. on an IKA Basic heating plate, with a stirring speed of 300 rpm. The oil was then added to the water phase. The emulsion was kept at 80° C. for 25 minutes, with a stirring speed set on minimum speed. The heating was then stopped, and the emulsion was cooled down to room temperature with the stirring on.

1c Emulsion with Ionic Surfactants-CT8, CT9-CT12 and CT16-CT20

Cationic (Cetyltrimethylammonium bromide, CTAB, CT17-CT20) and anionic (Sodium Dodecyl Sulfate, SDS, CT9-CT12) surfactant were dissolved in water (either 0.5 g (CT9, CT11, CT17, CT19) or 2.5 g (CT10, CT12, CT18, CT20) in 92 g of water) with a magnetic stirrer IKA RH Basic 2 at speed 4. 8 g of canola oil was added to the solution, which was then emulsified. The emulsification was done either with an IKA RH basic 2 at speed 4 for 5 minutes (CT9, CT10, CT17, CT18), or with a high shear emulsifier Kinematica Polytron PT-10-35 at level 5 for 1 minutes (CT11, CT12, CT19, CT20).

Similarly, soy lecithin was used as an emulsifier (CT8). 5 g were dissolved in 87 g of water, before adding 8 g of vegetable oil. The emulsification was performed with an IKA RH basic stirrer at speed 4 for 5 minute.

SDS was also used instead of SP70; 35 g of SDS was mixed with 10 g of SP30, and the emulsion was prepared as in example 1b (CT16).

1d Single Sucrose Ester Emulsions with Ethanol—CT1, CT2

The water phase was prepared by mixing 367 g of MilliQ water with 45 g of sucrose ester emulsifier (either SP30 for CT2 or SP70 for CT1) and heating this solution to 80° C. with the stirring speed set on level 1. The oil phase was prepared by mixing 50 g of ethanol and 40 g of vegetable oil and heating this solution to 75° C. on a IKA RH Digital magnetic stirrer set at 300 rpm. After adding the oil to the water phase, the emulsion was kept at 80° C. for 25 minutes, with a stirring speed set on minimum speed. The heating was then stopped, and the emulsion was cooled down to room temperature with the stirring on.

1e Single Sucrose Ester Emulsions without Ethanol—CT5, CT14, CT21, CT23-CT26, CT29, CT31-CT34

The water phase was prepared by mixing 367 g of MilliQ water (dionized water for CT31; tap water for CT32) with 35 g (CT5) or 45 g of sucrose ester emulsifier (either SP30 (CT21) or SP70 (CT14, CT23-CT26, CT29, CT31-CT34) and heating this solution to 80° C. with the stirring speed set on level 1. For CT29, 0,5 g of potassium sorbate (E202) preservative was also added to the water phase. The vegetable oil (canola for CT5, CT14, CT21, CT23; 50/50 vol % canola/olive for CT24, CT29, CT31-CT34) was heated to 75° C. on a IKA RH Digital magnetic stirrer set at 300 rpm. After adding the oil (always 40 g except CT33: 20 g and CT34: 30 g) to the water phase, the emulsion was kept at 80° C. for 25 minutes, with a stirring speed set on minimum speed. The heating was then stopped, and the emulsion was cooled down to room temperature with the stirring on.

1f Emulsions without Oils—CT6, CT13, CT27, CT28

Sucrose esters (SP70 (CT27), SP30 (SP28) or a combination of both (CT6 with ethanol, CT13 without ethanol) were dissolved in water at 80° C. with stirring speed set on 1, and further kept at 80° C. for 25 minutes, with a stirring speed set on minimum speed. The heating was then stopped, and the emulsion was cooled down to room temperature with the stirring on.

### 1 g Comparative Data

Applicants attempted to reproduce coatings that are described in previous patent documents, more specifically in “WO 2020/226495 A1-Edible coating composition for coating fresh harvest products”, “U.S. Pat. No. 4,649,057-Preservative coating method for preserving fresh foods” and in “EP 2 962 573 A1-Method for extending shelf-life of fresh food products”.

U.S. Pat. No. 4,469,057 A (Thomson) was mimicked by mixing 300 g water and 0,6 g SDS at 80° C., and emulsifiying it with a mixture of 6 g vegetable oil and 3 g oleic acid heated at 80° C. The emulsification was done at 80° C. for 5 minutes, with stirring speed set on 1.

WO 2020/226495 A1 (LiquidSeal) was mimicked by mixing 100 mL water with 5 g vegetable oil, 3 g oleic acid, 5 g ammonia 25% and 0.1 g glycerol. The emulsification was done with a Kinematica Polytron PT-10-35 at level 5 for 1 minute.

EP 2 962 573 A1 (Corrias) was mimicked by dissolving 60 g of honey in 1000 mL of water at room temperature, and by bathing the crops 2×30 seconds in this solution. After letting the crop to dry for 25 minutes, vegetable oils was sprinkled on its surface with a perfume spray.

### 1h Final Emulsion Dilution and Application

The stock solution was further diluted with MilliQ water to 10% or 15 wt % (e.g. 15 g of the stock emulsion+85 g of MilliQ water to get a 15% emulsion. At 15% dilution, there is 1,33% of oil in the total volume that is applied. This diluted emulsion was transferred into a sprayer, which was used to spray onto the crop surface. Preparations are summarized in Table 1.

TABLE 1

| | Emulsifier 1 | | Emulsifier 2 | | Ethanol | | Oil | |
|---|---|---|---|---|---|---|---|---|
| | | Amount | | Amount | | Amount | | Amount |
| NAME | Type | [g] | Type | [g] | Yes/No | [g] | Type | [g] |
| Cooking Test 3 | SP70 | 3.5 | SP30 | 1 | Yes | 50 | canola | 40 |
| Cooking Test 4 | SP70 | 17.5 | SP30 | 5 | Yes | 50 | canola | 40 |
| Cooking Test | SDS | 35 | SP30 | 10 | no | NA | canola | 40 |
| 16 | | | | | | | | |
| Cooking Test 8 | Soy | 5 | NA | NA | No | Na | canola | 8 |
| | lecitin | | | | | | | |
| Cooking Test 2 | SP30 | 22.5 | SP30 | 22.5 | Yes | 50 | canola | 40 |
| Cookint Test 21 | SP30 | 45 | NA | NA | no | NA | canola | 40 |
| Cooking Test 5 | SP70 | 35 | NA | NA | No | NA | canola | 40 |
| Cooking Test 1 | SP70 | 45 | NA | NA | Yes | 50 | canola | 40 |
| Cooking Test | SP70 | 45 | NA | NA | no | NA | canola | 40 |
| 14 | | | | | | | | |
| Cooking Test | SP70 | 45 | NA | NA | NA | NA | canola/olive | 20 g/20 g |
| 23 | | | | | | | | |
| Cooking Test | SP70 | 45 | NA | NA | NA | NA | canola/sunflower | 20 g/20 g |
| 24 | | | | | | | | |
| Cooking Test | SP70 | 45 | NA | NA | NA | NA | sunflower | 40 |
| 25 | | | | | | | | |
| Cooking Test | SP70 | 45 | NA | NA | NA | NA | olive | 40 |
| 26 | | | | | | | | |
| Cooking Test | SP70 | 45 | NA | NA | NA | NA | canola/olive | 20 g/20 g |
| 29 | | | | | | | | |
| Cooking Test | SP70 | 45 | NA | NA | NA | NA | canola/olive | 20 g/20 g |
| 31 | | | | | | | | |
| Cooking Test | SP70 | 45 | NA | NA | NA | NA | canola/olive | 20 g/20 g |
| 32 | | | | | | | | |
| Cooking Test | SP70 | 45 | NA | NA | NA | NA | canola/olive | 10 g/10 g |
| 33 | | | | | | | | |
| Cooking Test | SP70 | 45 | NA | NA | NA | NA | canola/olive | 15 g/15 g |
| 34 | | | | | | | | |
| Cooking Test 6 | SP70 | 35 | SP30 | 10 | Yes | 50 | NA | NA |
| Cooking Test | SP70 | 35 | SP30 | 10 | no | NA | NA | NA |
| 13 | | | | | | | | |
| Cooking Test | SP70 | 45 | NA | NA | NA | NA | NA | NA |
| 27 | | | | | | | | |
| Cooking Test | NA | NA | SP30 | 45 | NA | NA | NA | NA |
| 28 | | | | | | | | |
| Cooking Test 7 | SP70 | 35 | SP30 | 10 | Yes | 50 | oleic acid | 40 |
| Cooking Test | SP70 | 35 | SP30 | 10 | no | NA | oleic acid | 40 |
| 15 | | | | | | | | |
| C | SP70 | 35 | SP30 | 10 | Yes | 50 | canola | 40 |
| Cookint Test 22 | SP70 | 35 | SP30 | 10 | no | NA | canola | 40 |
| Beta | SP70 | 35 | SP30 | 10 | no | NA | Canola/Olive | 20 g/20 g |
| Beta w | SP70 | 35 | SP30 | 10 | yes | 50 | Canola/Olive | 20 g/20 g |
| Cooking Test | SP70 | 35 | SP30 | 5 | no | no | canola/olive | 8 |
| 30 | | | | | | | | |
| Cooking Test 9 | SDS | 0.5 | NA | NA | no | NA | canola | 8 |
| Cooking Test | SDS | 2.5 | NA | NA | no | NA | canola | 8 |
| 10 | | | | | | | | |
| Cooking Test | SDS | 0.5 | NA | NA | no | NA | canola | 8 |
| 11 | | | | | | | | |
| Cooking Test | SDS | 2.5 | NA | NA | no | NA | canola | 8 |
| 12 | | | | | | | | |
| Cooking Test | CTAB | 0.5 | NA | NA | no | NA | canola | 8 |
| 17 | | | | | | | | |
| Cooking Test | CTAB | 2.5 | NA | NA | no | NA | canola | 8 |
| 18 | | | | | | | | |
| Cooking Test | CTAB | 0.5 | NA | NA | no | NA | canola | |
| 19 | | | | | | | | |
| Cooking Test | CTAB | 2.5 | NA | NA | no | NA | canola | |
| 20 | | | | | | | | |

### Example 2

A set of 29 different coatings were prepared, as described above in Example 1.

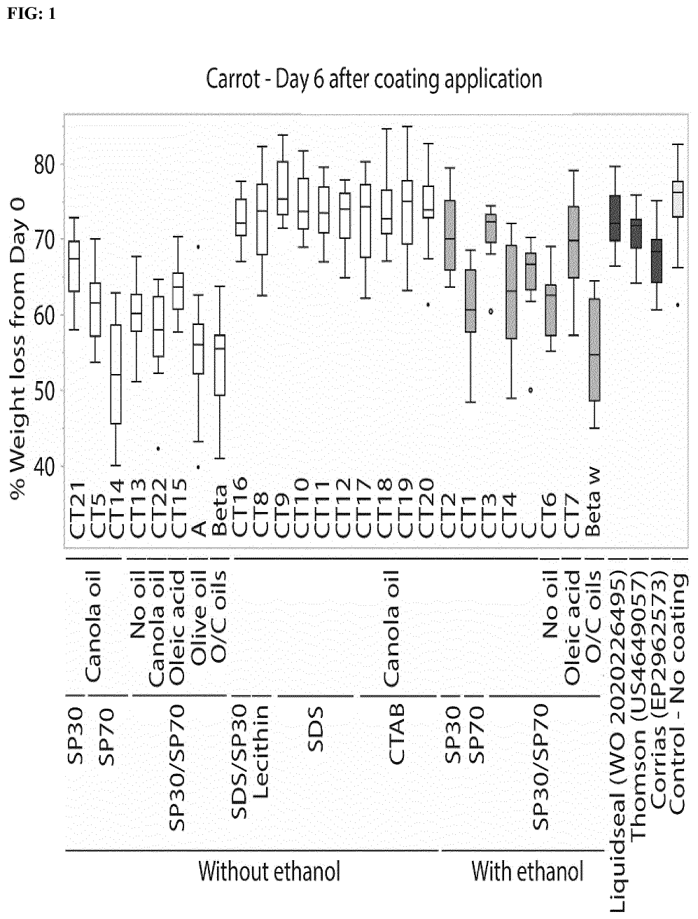

Carrots were bought from a local grocery shop, and weighted individually before being randomly distributed in plastic racks containing 4 or 5 carrots each. For each coating tested, three racks (total 14 carrots per modality) were used. Each carrot was sprayed individually, and kept at room temperature in the dark. After 6 days, the carrots were weighted again and the weight loss was calculated according to the formula, Weight loss=100−[(WeightDay6/WeightDay0)*100]. Results are shown in FIG. 1.

### Conclusion:

FIG. 1 highlighted that the coating providing the better protection against dehydration is CT14, which is made out of Canola oil and SP70 sucrose ester emulsifier. Combination of oils such as canola and olive (beta coating) also show great properties, better than single oils (beta vs. A (olive) and CT22 (canola)).

The emulsion prepared with other emulsifier than sucrose esters (Anionic Sodium Dodecyl Sulfate SDS-cationic Cetyltrimethylamonium bromide CTAB-soy lecithin) appears to be less effective in preventing water evaporation (FIG. 1). This is confirmed by two coating having respectively 10× and 2× less sucrose ester (CT3 and CT4).

When comparing the coatings of this invention with the ones already reported (U.S. Pat. No. 4,469,057 A (Thomson), WO 2020/226495 A1 (LiquidSeal), EP 2 962 573 A1 (Corrias)—black boxes in FIG. 1), one can see that they are all less efficient in preventing water loss from carrots. There is no advantages of using ethanol in the preparation of the coatings of the present invention (grey boxes; for equivalent recipes with and without ethanol see table of example 1).

Indeed, weight loss is lower when the applied coating has been prepared without having ethanol in its composition.

Applicants observed an increase of 8.1% and 11.0% of water loss in carrots for those treated with a coating strictly made of sucrose esters SP30/SP70 (CT13 and CT6 respectively) compared to a coating made of sucrose esters SP30/SP70 and a combination of canola and olive oils (Beta and Beta W respectively). Consequently, adding vegetable oils to the coating provide a non-negligeable advantage in term of water loss.

### Example 3

A set of 26 different coatings were prepared, as described in Example 1.

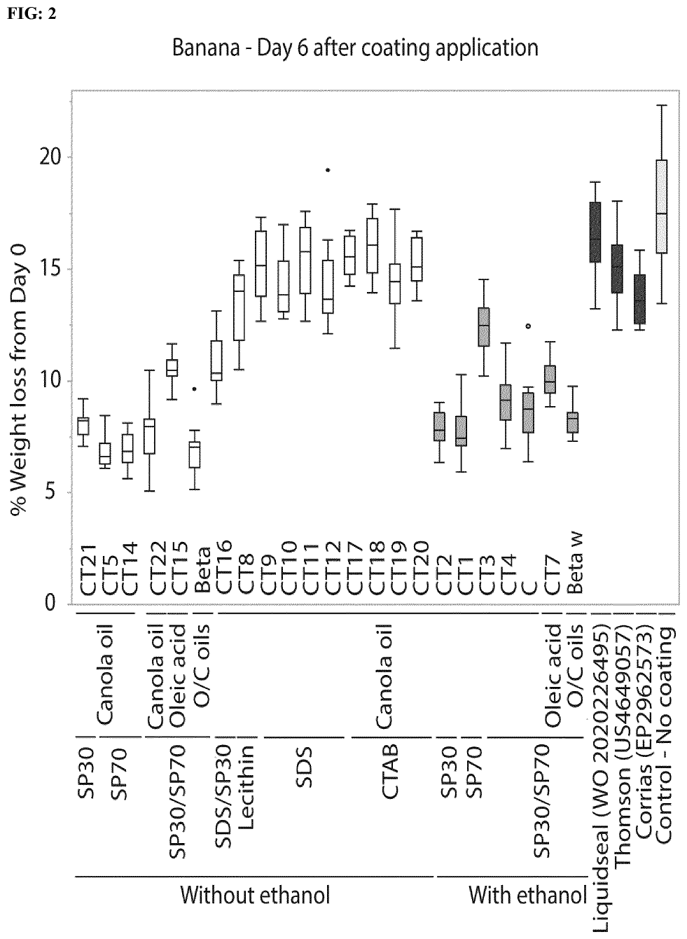

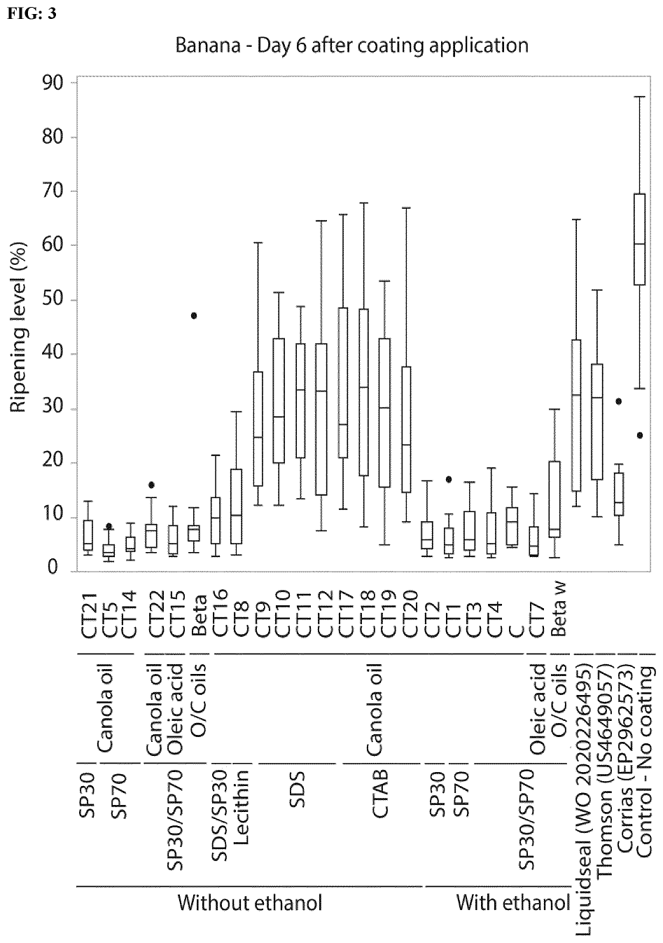

Bananas were bought from a local grocery shop, and weighted individually before being randomly distributed in plastic racks containing 4 bananas each. For each tested coating, three racks (total 12 bananas per modality) were used. Each banana was sprayed individually, and kept at room temperature in the dark. After 6 days, the bananas were weighted again and the weight loss was calculated according to the formula, Weight loss=100−[(WeightDay6/WeightDay0)*100]. The % of ripening of bananas was evaluated based on pictures analysed with the software ImageJ (Schindelin et al. 2012). Results are shown in FIGS. 2 and 3.

Conclusion: The trend observed in Example 2 for the carrots is very similar to the one obainted for bananas. The emulsion obtained with CTAB, SDS or soy lecithin do not provide a good protection against water loss, as opposed to the sucrose-ester based coatings (FIG. 2).

Prior art coatings (U.S. Pat. No. 4,469,057 A (Thomson), WO 2020/226495 A1 (LiquidSeal), EP 2 962 573 A1 (Corrias)—in black) are less efficient than the coatings of the present invention to prevent weight loss on bananas. Using ethanol in the preparation of the coatings does not lead to a better protection against weight loss. Ripening was slower in coated bananas compared to control ones and sucrose-ester based coating were more efficient than others (FIG. 3).

### Example 4

A set of 20 different coatings were prepared, as described in Example 1.

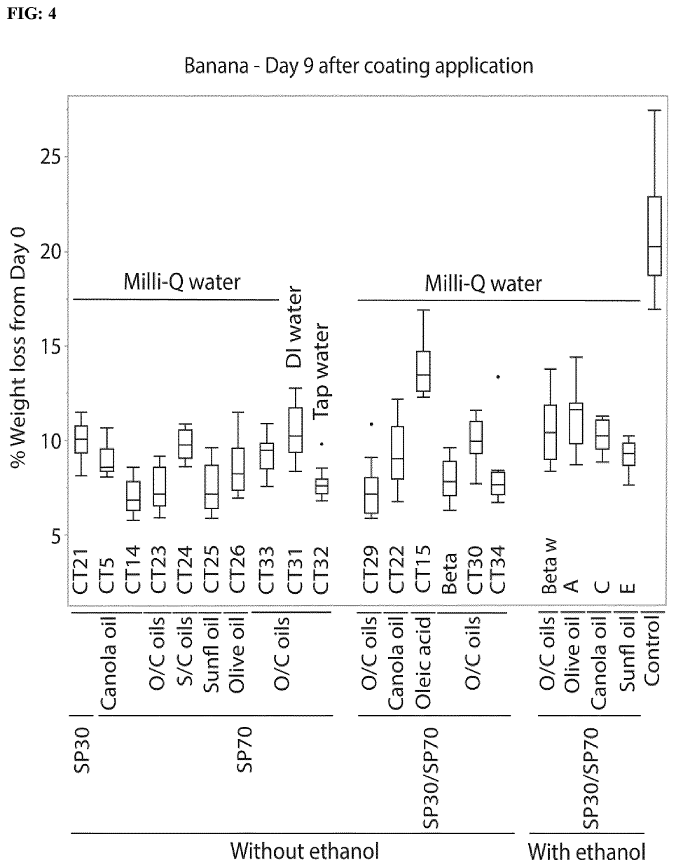

Bananas were bought from a local grocery shop, and weighted individually before being randomly distributed in plastic racks containing 4 bananas each. For each tested coating, three racks (total 12 bananas per modality) were used. Each banana was sprayed individually, and kept at room temperature in the dark. After 9 days, the bananas were weighted again and the weight loss was calculated according to the formula, Weight loss=100−[(WeighDay9/WeightDay0)*100]. This example focused strictly on sucrose-ester based coating in order to compare the advantage of using one or two different sucrose ester (SP30 and SP70; with or without ethanol), combined with different vegetable oils or oleic acid. Different types of water were also tested, i.e. tap, DI or Milli-Q. Results are shown in FIG. 4.

Conclusion: FIG. 4 revealed that oleic acid is less efficient than vegetable oils and that ethanol does not help reducing water loss of bananas. It also show that weight loss reduction can be achieved by using one or two types of sucrose esters. Similarly, using tap, DI or Milli-Q water in the coating composition lead to relatively similar protection against weight loss.

### Example 5

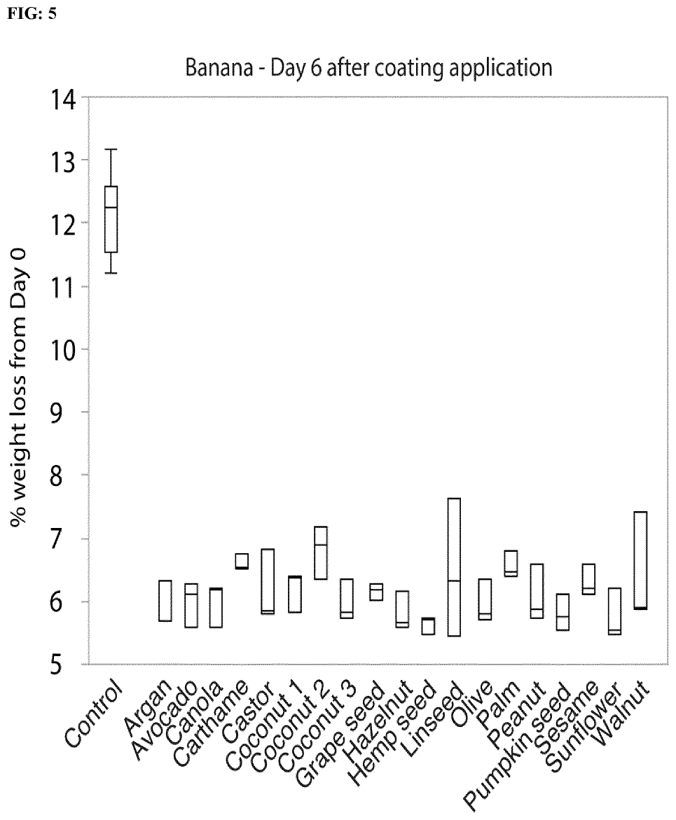

A set of 19 different coatings were prepared by using 19 different vegetable oils, i.e. argan, avocado, canola, safflower, castor, coconut (three different brands), grape seed, hazelnut hemp seed, linseed, olive, palm, peanut, pumpkin seed, sesame, sunflower and walnut. The recipe “C” described in example 1 was used, with canola oil being replaced by different vegetable oils. Bananas were bought from a local grocery shop, and weighted individually before being randomly distributed in plastic racks containing 4 bananas each. For each tested coating, three racks (total 12 bananas per modality) were used. Each banana was sprayed individually, and kept at room temperature in the dark. After 6 days, the bananas were weighted again and the weight loss was calculated according to the formula, Weight loss=100−[(WeightDay6/WeightDay0)*100]. Results are shown in FIG. 5.

Conclusion: This example showed that different vegetable oils can be used in coating for reducing significantly the weight loss in bananas (FIG. 5).

### Example 6

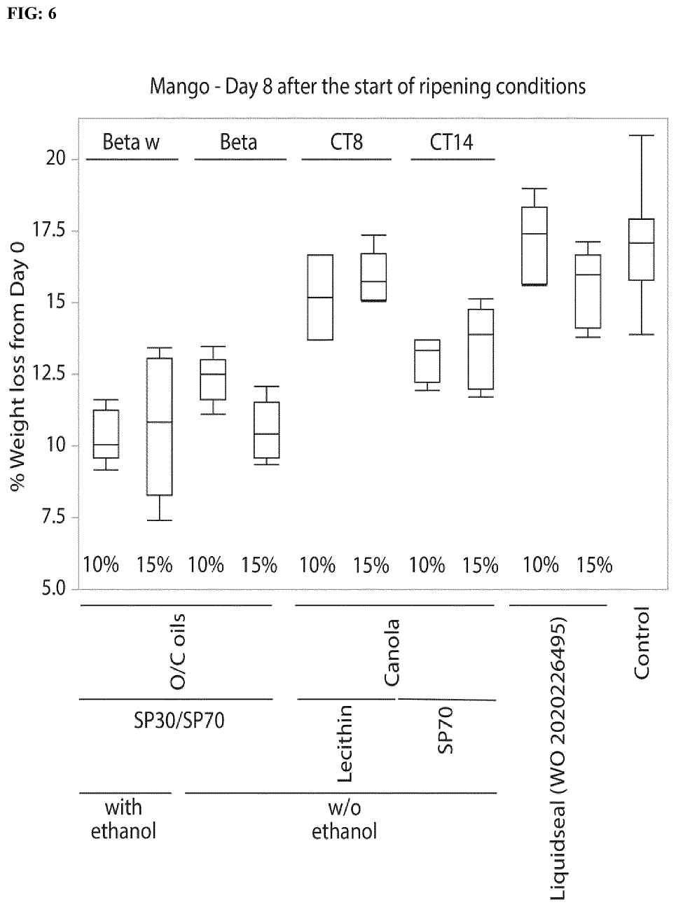

A set of 4 different coatings containing sucrose-esters and canola alone or a combination of canola and olive oils were prepared at to different final concentrations (10 and 15%), as described in example 1, as well as a coating mimicking the one of liquidseal at 10 and 15%. Mangoes were bought from a local grocery shop, and weighted individually before being randomly distributed in plastic racks containing 8 mangoes each. For each tested coating, two racks (total 16 mangoes per modality) were used. Each mango was sprayed individually, and kept at room temperature in the dark. After 8 days of ripening, the mangoes were weighted again and the weight loss was calculated according to the formula, Weight loss=100−[(WeightDay8/WeightDay0)*100]. Results are shown in FIG. 6.

Conclusion: Applicants highlighted that different concentration of coatings (10-15%) containing one or two sucrose-esters and one or two vegetable oils can reduce weight loss in mangoes compared to non-coated mangoes and that lecithin based coating was less efficient compared to the previous ones. Finally, mangoes coated with the solution mimicking Liquidseal provided no weight loss reduction (see FIG. 6).

### Example 7

A set of 35 different coatings were prepared, as described in example 1.

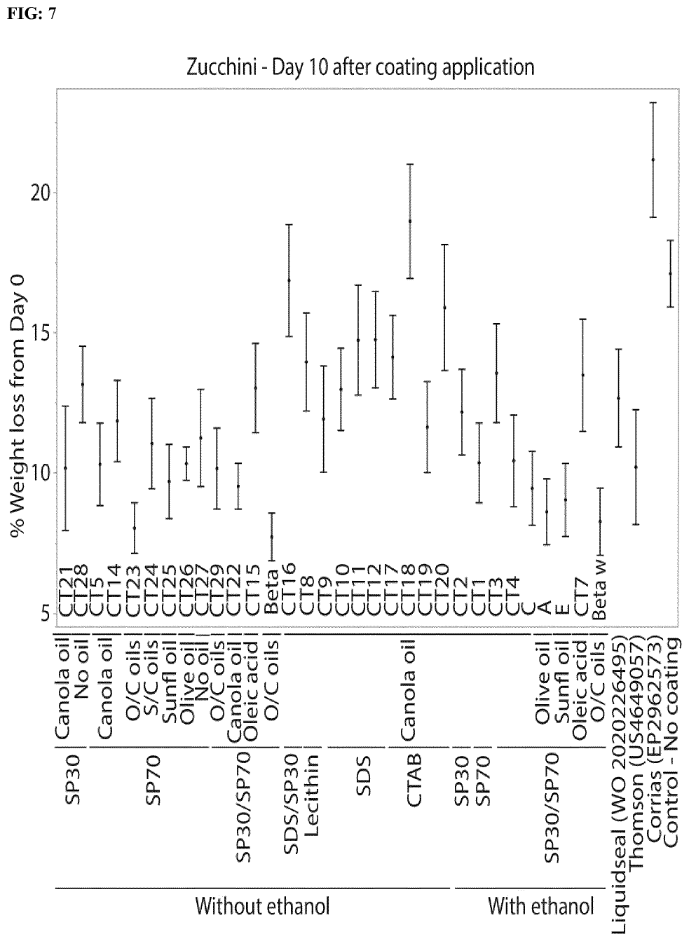

Zucchinis were bought from a local grocery shop, and weighted individually before being randomly distributed in plastic racks containing 4 or 3 zucchinis each. For each coating tested, three rack (total 10 zucchinis per modality) were used. Each zucchini was sprayed individually, and kept at room temperature in the dark. After 10 days, the zucchinis were weighted again and the weight loss was calculated according to the formula, Weight loss=100−[(WeightDay10/WeightDay0)*100]. Results are shown in FIG. 7.

Conclusion: The two best coatings were made of a combination of olive and canola oils and one (CT23) or two (Beta) types of sucrose esters (see FIG. 7). The emulsion prepared with other emulsifier than sucrose esters (Anionic Sodium Dodecyl Sulfate SDS-cationic Cetyltrimethylamonium bromide CTAB-soy lecithin) appears to be less effective in preventing weight loss. Already reported coating from Thomson and LiquidSeal were less efficient at preventing weight loss than CT23 and Beta. Finally, the one from Corrias had a negative effect on weight loss in zucchinis.

Applicants observed an increase of 40.29% of water loss in zucchinis for those treated with a coating strictly made of sucrose esters SP70 (CT27) compared to a coating made of SP70 and a combination of canola and olive oils (CT23) and 29.40% with a coating made strictly of sucrose esters SP30 compared to a coating made of SP30 and canola oil (CT23). Consequently, adding vegetable oils to the coating provide a strong advantage in term of water loss.

### Example 8

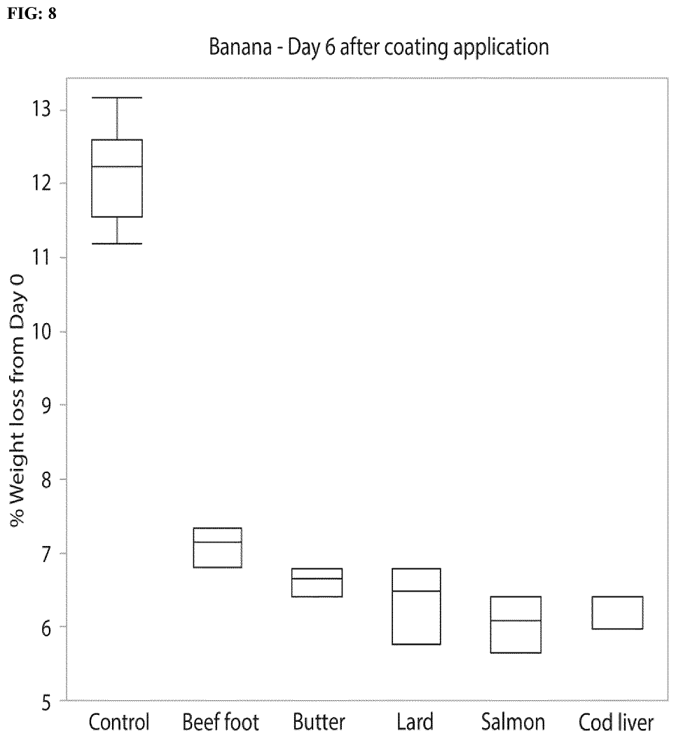

A set of 5 different coatings were prepared by using 5 different oils and butters from animal origin, i.e. beef foot, lard, butter, cod liver and salmon. The recipe “C” described in example 1 was used, with canola oil being replaced by different animal oils or butter. Bananas were bought from a local grocery shop, and weighted individually before being randomly distributed in plastic racks containing 4 bananas each. For each tested coating, three racks (total 12 bananas per modality) were used. Each banana was sprayed individually, and kept at room temperature in the dark. After 6 days, the bananas were weighted again and the weight loss was calculated according to the formula, Weight loss=100−[(WeightDay6/WeightDay0)*100]. Results are shown in FIG. 8.

Conclusion: This example showed that different animal oils and butter can be used in coating for reducing significantly the weight loss in bananas (see FIG. 8).

### Example 9

In this example, Applicants roughly estimated the minimal amount of vegetable oil needed in Applicant's coating made of sucrose esters, vegetable oil(s), water and ethanol (only for Beta W and CT6 in this example) for providing a significant advantage in term of weight loss compared to a coating strictly made of sucrose esters, water and ethanol. Applicants assumed a negative linear relationship between the amount of oils in the coating (with a fixed amount of sucrose esters) and the weight loss of crops, i.e. the weight loss of crops increases linearly with the decrease of the amount of oil present in the coating to the point where only sucrose esters are left.

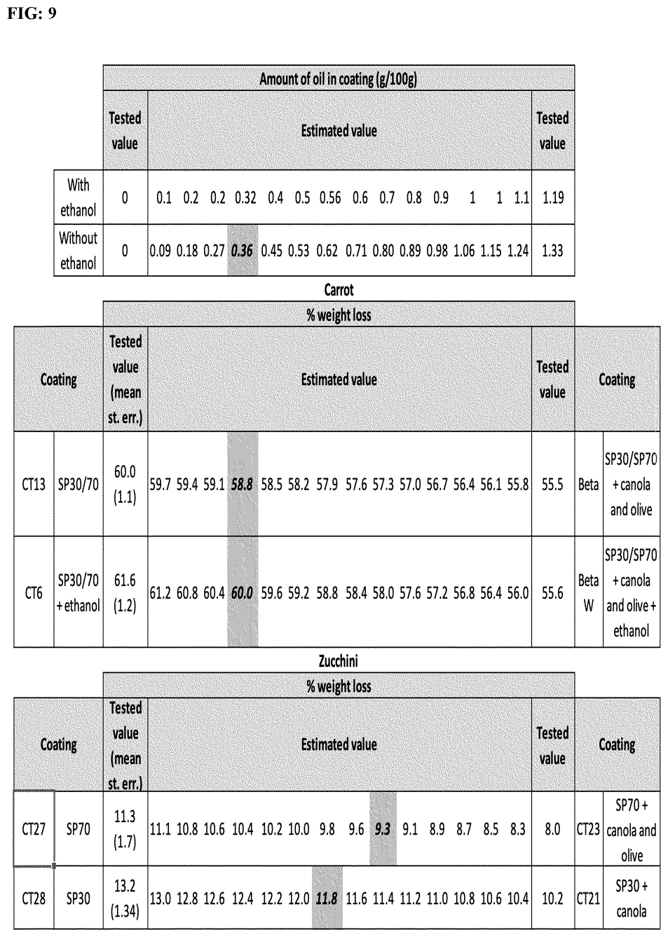

To this respect Applicants compared the water loss in (i) carrots treated with strictly sucrose esters (SP30/SP70; CT13 and CT6) to coatings made of sucrose esters (SP30/SP70) and a combination of olive and canola oils (Beta and Beta W, respectively) and (ii) zucchinis treated strictly with sucrose esters (SP30, CT28; SP70, CT27) and coatings made of sucrose esters and vegetable oils (CT21 [SP30+canola oil] and CT23 [SP70+combination of olive and canola oils] respectively). FIG. 9 summarizes the results.

As an estimate of a reasonable difference in weight loss between pairs of coatings (i.e. with or without oil(s)), Applicants considered that an advantage of adding a certain amount of oil is determined by an estimated value of weight loss not comprised in the range (considering the mean standard error) of weight loss of the coating without oil.

Conclusion: Applicants estimated that for carrots, a coating comprising at least 0.32 g of oil per 100 g of solution is providing an advantage in term of weight loss compared to a coating with no oil. For zucchinis, a minimal amount of oil comprised between 0.62 and 0.8 g per 100 g (depending of the coating) provides an advantage.

### Example 10

A set of 4 different coatings containing sucrose-esters and a combination of canola and olive oils were prepared at to different final concentrations (3, 5, 8, 10, 12%), as described in example 1, as well as a 7% (as recommended by pineapples growers) Pineapple Lustr 444® from Decco® (containing microcrystalline wax).

Decco® is one of the leaders of post-harvest solution for fresh fruits and vegetables. They offer various products such as coatings, sanitizers and fungicides. Their coatings are microcrystalline wax-based products, mainly for citrus fruits or exotic fruits such as pineapple. Such a product is Decco® LUSTR-444®, whose Safety Data Sheet can be found at https://www.deccoitalia.it/portfolio/ananas/?lang=en

70 pineapples were obtained from a producer and weighted individually before being randomly distributed among treatments (10 per treatments, including a control).

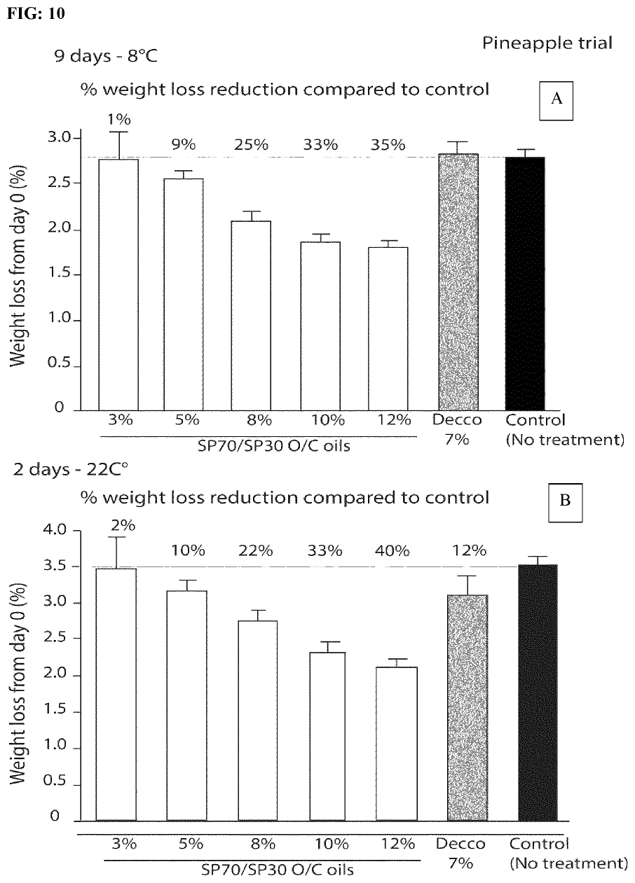

Each pineapple was dipped individually in coating and stored 9 days at 8° C. and then two days at 22° C., as performed in a storage facility dedicated to pineapples. After 9 days at 8° C., the pineapples were weighted again and the weight loss was calculated according to the formula, Weight loss=100−[(WeightDay9/WeightDay0)*100]. Finally, pineapples were weighted again after two days of ripening at 22° C. and the weight loss was calculated according to the formula, Weight loss=100−[(WeightDay11 (9+2)/WeightDay0)*100]. Results are shown in FIG. 10.

Conclusion: Applicants highlighted that different concentration of coatings (3-12%) containing two sucrose-esters and two vegetable oils can reduce weight loss in pineapples up compared to non-coated pineapples at 8 and 22° C. and that Pineapple Lustr 444® from Decco® provided no weight loss reduction at 8° C. (see FIG. 10). At 22° C., the coating of the invention performed much better than Pineapple Lustr 444® from Decco® (weight loss reduction of 7% compared to non-coated pineapples) for concentration of 8 (weight loss reduction of 22%), 10 (33%) and 12% (40%). At 8° C., Pineapple Lustr 444® did not reduce the weight loss compared to non-treated pineapples, whereas a reduction of up to 35% was observed with the coatings of the invention.

### Example 11: Comparative Data

A set of different coating were prepared according to patent applications WO 2021/187970 A1, WO 2018/174699 A1, CN 105557991 A, CN 103859015 A (see below) and compared to a coating according to the present invention containing sucrose-esters and a combination of canola and olive oils at a concentration of 15% (as described in example 1), as well to Pineapple Lustr 444® from Decco® (containing microcrystalline wax) and to a mixture (50/50) of canola and olive oils.

18 g of either carnauba wax or bee wax was melted in a beaker until liquid. In another beaker, 200 mL of hot water (90° C.) was mixed with a plasticizer and a non-ionic emulsifier at 800 rpm on an IKA heating plate. Then the melted wax was poured in the aqueous solution and stirred at 800 rpm for 15 minutes. Finally, the emulsion was prepared with a high shearing device operating at 15000 rpm for 2×30 seconds.

Representative example: 18 g carnauba wax or bee wax; 200 g water; 2 g glycerol; 4 g Tween 20 (Carnauba 1; beewax 1); 18 g carnauba oil; 200 g water; 4 g glycerol; 6 g Tween 20 (Carnauba 2; beewax 2); 18 g carnauba oil; 200 g water; 2 g glycerol; 4 g Tween 80 (Carnauba 3; beewax 3).

### CN 105557991 A

In a beaker, 170 mL of hot water (90° C.) was mixed with 10.3 g of EtOH 50%, 0,3 g of potassium sorbate and 1,5 g of a non-ionic emulsifier, followed by 5.9 g of Moringa oleifera seed oil, and stirred at 800 rpm on an IKA heating plate for 15 minutes. Finally, the emulsion was prepared with a high shearing device operating at 15000 rpm for 2×30 seconds.

Representative example: 5.9 g Moringa oleifera seed oil, 170 g water, 0.3 g potassium sorbate, 10.3 g EtOH 50%, 1.5 g Tween 20 (Moringa 1) or Tween 80 (Moringa 2).

### CN 103859015 A

In a beaker, 200 mL of hot water (90° C.) was mixed with 3 g of EtOH and 15 g of a non-ionic emulsifier, followed by 4 g of canola oil and 4 g of olive oil, and stirred at 800 rpm on an IKA® heating plate for 15 minutes. Finally, the emulsion was prepared with a high shearing device operating at 15000 rpm for 2×30 seconds.

Representative example: 200 g water, 3 g EtOH 100%, 15 g Tween 20 or Tween 80 or a mixture of Tween 20 and 80 (Tween mix 1-11.55 g Tween 20+3.45 g Tween 80; Tween mix 2-3.45 g Tween20/11.55 g Tween 80), 4 g canola oil and 4 g olive oil.

Concerning the preparation of the pilot test, bananas with a biological label were obtained from a local grocery store and distributed in plastic boxes. Triplicates of 4 fruits were prepared for each modality tested. Then, bananas were weighted and sprayed with the different coating solutions and stored at room temperature. Weight was monitored at day 0 and then 2 days later and the weight loss was calculated according to the formula, Weight loss=100−[(WeightDay2/WeightDay0)*100].

Table 2 shows the % weight loss reduction of coating compared to non-treated control, 2 days after its application, as well as the HLB of the emulsifiers used in the different coatings.

TABLE 2

| Coating | % weight loss reduction | HLB |
|---|---|---|
| C/O oils SP30/70 | 52.3 | 12.9 |
| Beewax 1 | 32.2 | 16.7 |
| Beewax_3 | 32.1 | 15 |
| Tween20 | 31.3 | 16.7 |
| Tween80 | 31.2 | 15 |
| Oil | 28.6 | NA |
| Carnauba 1 | 28.5 | 16.7 |
| Moringa_2 | 28.1 | 15 |
| Decco_7% | 28 | NA |
| Tween Mix 1 | 27.3 | 16.3 |
| Carnauba 2 | 26.7 | 16.7 |
| Span80 | 26.1 | 4.3 |
| Tween Mix 2 | 24.3 | 15.4 |
| Beewax 2 | 24.3 | 16.7 |
| Span20 | 23.8 | 8.6 |
| Carnauba_3 | 20.2 | 15 |
| Moringa 1 | 19.5 | 16.7 |

Conclusion: Applicants highlighted that the coating of the invention containing two nonionic sucrose-esters and two vegetable oils can reduce weight loss in bananas by 52.3% compared to non-coated ones and is performing much better than the other coating tested (32.2% to 19.5%) from WO 2011/187970 A1, WO 2018/174699 A1, CN 105557991 A and CN 103859015 A. With this example, that covers a large range of HLB (from 4.3 to 16.7), applicants also highlighted that coatings with similar HLB can show strong differences in efficacy, which means that both HLB and physicochemical properties of the coating are crucial and play a key role.

### Example 12

A set of 11 different coatings of the invention were prepared, as described in example 1 and contained one single oil (canola, safflower, olive and sunflower) or a combination of two of them.

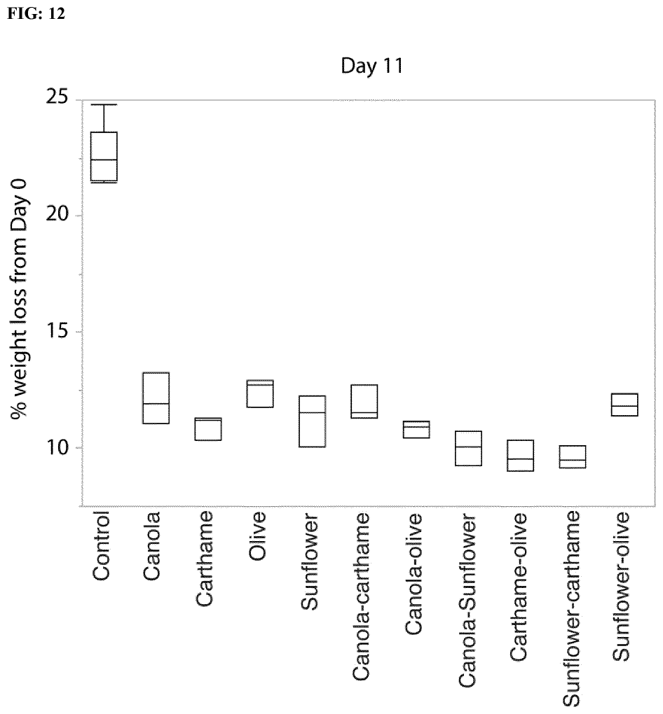

Bananas were bought from a local grocery shop and weighted individually before being randomly distributed in plastic racks containing 4 bananas each. For each tested coating, three racks (total 12 bananas per modality) were used. Each banana was sprayed individually at a concentration of 15% and kept at room temperature in the dark. After 11 days, the bananas were weighted again and the weight loss was calculated according to the formula, Weight loss=100−[(WeightDay11/WeightDay0)*100]. Then weight loss was compared between coatings as well as with non-coated bananas. Results are shown in FIG. 12.

Conclusion: Applicants highlighted that all the coatings according to the invention reduced the weight loss of bananas compared to the control. In addition, coatings made of a combination of two oils, i.e. canola-olive, canola-sunflower, safflower-olive and sunflower-safflower were more efficient at reducing weight loss than coatings made of strictly one of these oils, i.e. canola, olive, safflower and sunflower alone. Thus, combining two oils brings advantages in term of weight loss.

### Example 13

Example of monoester percentage calculation-blending different products

Example of Calculation with Sisterna®

Sisterna's® Sucrose ester emulsifiers are mixed palmitate (C16) and stearates (C18) esters, and their HLB ratio is tuned by the percentage of monoester in the blend. For example, SP30 contains 30% of monoester and 70% of polyester in weight, and has an HLB of 6. Another product SP50 contains 50% of monoester and 50% of polyester weight, with an HLB of 11. For a 50/50 w/w mix of these two product, the final blend contains (0.5*30%)+(0.5*50%)=40% of monoester and (0.5*70%)+(0.5*50%)=60% of polyester. The HLB value of this mix is therefore (0.5*6)+(0.5*11)=8.5.

In another example, Sisterna's® Sucrose Ester emulsifier SP30 (30% monoester and 70% polyester, HLB 6) and SP70 (30% monoester and 70% polyester, HLB 15) are mixed at 23/77 w/w SP30/SP70 ratio. The final blend has a weight percentage of (0.23*30%)+(0.77*70%)=60.8% of monoester and (0.23*70%)+(0.0.77*30%)=39.2% of polyester. Thus the HLB value of this mix is (0.23*6)+(0.77*15)=12.93.

Example of Calculation with RYOTO®

Ryoto® Sugar ester S-370 consists of 20% of monoester and 80% of polyester in weight and has an HLB of 3. P-1670 consists of 80% of monoester and 20% of polyester in weight and has an HLB of 16. A blend containing 30/70 w/w s-370/S-1670 has (0.3*20%)+(0.7*80%)=62% of monoester and (0.7*80%)+(0.3*20%)=38% of polyester in weight and a HLB of (0.3*3)+ (0.7*16)=12.1.

### Example of 60% Processability

The processability of the coating solution mainly depends on the wettability of the sucrose ester emulsifiers used. If a too hydrophobic emulsifier (low HLB) is used, it won't dissolve in water at all, and emulsification of the oil will become difficult or almost impossible. It was determined that the ideal percentage of sucrose monoester versus sucrose polyester is 60% in total weight of said two sucrose fatty acid ester emulsifiers, corresponding to a final hydrophilic-lipophilic balance (HLB) of 13.

### Example of Viscosity of the Coating According to the Invention-Dilution 15%

A coating according to the invention consisting of 4.42% of olive oil, 4.42% of canola oil, 7.74% of SP70 sucrose ester emulsifier and 2.21% of SP30 sucrose ester emulsifier was prepared as explained in example 1 (Beta without ethanol), and diluted to 15% as in example 1 h. The viscosity of the final diluted product is 57.6 mPa*s, when measured according to Pharmacopoeia Europe (Ph. Eur.) 2.2.10 with a spindle N°18 at 50 rpm.

### Example 14

A set of three different coatings according to the invention with emulsifiers having different HLB balance were prepared as in example 1. Pure SP30 (HLB=6), pure SP70 (HLB=15) and a mixture SP70/SP30 77/23 w/w (HLB=12.9) were used.

Carrots were bought from a local grocery shop and weighted individually before being randomly distributed in plastic racks containing 4 or 5 carrots each. For each coating tested, three racks (total 14 carrots per modality) were used. Each carrot was sprayed individually and kept at room temperature in the dark. After 6 days, the carrots were weighted again and the weight loss was calculated according to the formula, Weight loss=100−[(WeightDay6/WeightDay0)*100]. The results are shown in Table 3.

Zucchinis were bought from a local grocery shop and weighted individually before being randomly distributed in plastic racks containing 4 or 3 zucchinis each. For each coating tested, three rack (total 10 zucchinis per modality) were used. Each zucchini was sprayed individually and kept at room temperature in the dark. After 10 days, the zucchinis were weighted again and the weight loss was calculated according to the formula, Weight loss=100−[(WeightDay10/WeightDay0)*100]. The results are shown in Table 4.

TABLE 3
Carrot after 6 days

| | HLB | % weight loss |
|---|---|---|
| SP30 + canola | 6 | 66.3 |
| SP70 + canola | 15 | 61.6 |
| SP30 + SP70 + canola | 12.9 | 57.4 |

TABLE 4
Zuchinni after 10 days

| | HLB | % weight loss |
|---|---|---|
| SP30 + canola | 6 | 10.2 |
| SP70 + canola | 15 | 10.3 |
| SP30 + SP70 + canola | 12.9 | 9.5 |

Conclusion: Applicants highlighted that a coating composition made of a blend of emulsifiers having a HLB of 12.96 (approximately 13) performed better than a coating made with emulsifiers having an HLB of either 6 or 15.

### REFERENCES

Schindelin, J.; Arganda-Carreras, I. & Frise, E. et al. (2012) Fiji: an open-source platform for biological-image analysis, Nature methods 9 (7): 676-682.

1-22. (canceled)

23. A method for extending the freshness and/or slowing down the ripening and/or water loss of post-harvest fruits, vegetables, cut flowers, seeds and/or perishable food products, the method comprising:
applying an edible coating emulsion as a biofilm to the post-harvest fruits, vegetables, cut flowers, seeds and/or perishable food products,
wherein the edible coating emulsion comprises the combination of:
natural vegetable oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof, wherein said natural vegetable oils represent between 0.3% and 2.5% w/w of the total weight of the edible coating emulsion;
a mixture of two nonionic sucrose fatty acid ester emulsifiers consisting of sucrose monoester and sucrose polyester where the fatty acids are selected from the group consisting of stearic acid (C₁₈) and palmitic acid (C₁₆) or mixtures thereof, wherein the percentage of sucrose monoester versus sucrose polyester is comprised between 30 and 70% in weight of each of said two nonionic sucrose fatty acid ester emulsifiers corresponding to a final hydrophilic-lipophilic balance (HLB) of the mixture of said two nonionic sucrose fatty acid ester emulsifiers which is comprised between 6 and 15; and
water.

24. The method according to claim 23, wherein said natural vegetable oils are cold pressed oils.

25. The method according to claim 23, wherein the natural vegetable oils correspond to a mixture of two natural vegetable oils selected from the group consisting of canola, olive and sunflower.

26. The method according to claim 23, wherein the percentage of sucrose monoester versus sucrose polyester is 60% in total weight of said two sucrose fatty acid ester emulsifiers corresponding to a final hydrophilic-lipophilic balance (HLB) of 13.

27. The method according to claim 23, wherein said two nonionic sucrose fatty acid ester emulsifiers represent between 0.15% w/w and 1.5% w/w of the total weight of the edible coating emulsion.

28. The method according to claim 23, wherein said two nonionic sucrose fatty acid ester emulsifiers are mixed palmitates and stearates SP70 and SP30.

29. The method according to claim 23, wherein said edible coating emulsion is a microemulsion having an average particle size distribution of the oil droplets in the coating emulsion of around 20 micrometer in diameter.

30. The method according to claim 23, wherein a natural fungicide is combined to said edible coating emulsion.

31. An edible post-harvest fruits, vegetables, cut flowers, seeds and perishable food products preservative coating composition in the form of an oil in water (O/W) emulsion comprising the combination of:
natural vegetable oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof, wherein said natural vegetable oils represent between 0.3% and 2.5% w/w of the total weight of the edible coating emulsion;
a mixture of two nonionic sucrose fatty acid ester emulsifiers consisting of sucrose monoester and sucrose polyester where the fatty acids are selected from the group consisting of stearic acid (C₁₈) and palmitic acid (C₁₆) or mixtures thereof, wherein the percentage of sucrose monoester versus sucrose polyester is comprised between 30 and 70% in weight of each of said two nonionic sucrose fatty acid ester emulsifiers corresponding to a final hydrophilic-lipophilic balance (HLB) of the mixture of said two nonionic sucrose fatty acid ester emulsifiers which is comprised between 6 and 15; and
water.

32. The edible coating composition according to claim 31, wherein said natural vegetable oils are cold pressed oils.

33. The edible coating composition according to claim 31, wherein the natural vegetable oils correspond to a mixture of two natural vegetable oils selected from the group consisting of canola, olive and sunflower.

34. The edible coating composition according to claim 31, wherein the percentage of sucrose monoester versus sucrose polyester is 60% in total weight of said two sucrose fatty acid ester emulsifiers corresponding to a final hydrophilic-lipophilic balance (HLB) of 13.

35. The edible coating composition according to claim 31, wherein said two nonionic sucrose fatty acid ester emulsifiers represent between 0.15% w/w and 1.5% w/w of the total weight of the edible coating emulsion.

36. The edible coating composition according to claim 31, wherein said two nonionic sucrose fatty acid ester emulsifiers are mixed palmitates and stearates SP70 and SP30.

37. The edible coating composition according to claim 31, wherein said edible coating emulsion is a microemulsion having an average particle size distribution of the oil droplets in the coating emulsion of around 20 micrometer in diameter.

38. The edible coating composition according to claim 31, wherein a natural fungicide is combined to said edible coating emulsion.

39. A process for preparing the edible coating composition in the form of an oil in water (O/W) emulsion according to claim 31, the process comprising the steps of:
adding two nonionic sucrose fatty acid ester emulsifiers consisting of sucrose monoester and sucrose polyester, wherein the percentage of sucrose monoester versus sucrose polyester is comprised between 30 and 70% in weight of each of said two nonionic sucrose fatty acid ester emulsifiers corresponding to a final hydrophilic-lipophilic balance (HLB) of the mixture of said two nonionic sucrose fatty acid ester emulsifiers which is comprised between 6 and 15; in water and heating the resulting water phase at a temperature between 55° C. and 80° C., allowing the two nonionic sucrose fatty acid ester emulsifiers to dissolve,
heating natural vegetable oils selected from the group consisting of argan, avocado, canola, safflower, castor, coconut, grape seed, hazelnut, hemp seed, linseed, olive, palm, peanut, pumpkin seed, sesame, sunflower and walnut or mixtures thereof at least at 5° C. less than the water phase to obtain an homogeneous oil phase, and
mixing the oil phase to the water phase and heating said mixture for at least approximately 25 minutes at least at a temperature between 55° C. and 80° C., allowing said two nonionic sucrose fatty acid ester emulsifiers to dissolve, and cooling the resulting mixture down.

40. The process of claim 39, wherein the obtained mixtures are diluted from 5% to 20% in weight in water to prepare a ready for spray or ready for bath edible coating composition in the form of an oil in water (O/W) emulsion.
